(19) United States
(12) Patent Application Publication
(10) Pub. No.: US 2005/0200562 A1
(43) Pub. Date: Sep. 15, 2005

(54) Device and method for driving a plasma display panel, and a plasma display device

(76) Inventors: Jun-Young Lee, Cheonan-si (KR); Jun-Hyung Kim, Cheonan-si (KR); Nam-Sung Jung, Yongin-si (KR)

Correspondence Address: McGuireWoods LLP, Suite 1800, 1750 Tysons Boulevard, McLean, VA, 22102, US

(21) Appl. No.: 10/895,970

(22) Filed: Jul. 22, 2004

(30) Foreign Application Priority Data
Jul. 30, 2003 (KR) 2003-0052519

(51) Int. Cl. G09G 3/28

(52) U.S. Cl. 345/60

(57) ABSTRACT

In an energy recovery circuit of a PDP, after storing energy in the inductor, the panel capacitor is charged by using a resonance between the inductor and the panel capacitor and the stored energy. At that time, a voltage greater than a voltage Vₛ/2 is stored in an energy recovery capacitor. Then, the panel capacitor can be charged to Vₛ even when a parasitic component exists in the energy recovery circuit. In addition, the energy remaining in the inductor can be used in a discharge. Also, the charging time of the panel capacitor is shorter than the discharging time of the panel capacitor to allow stable discharge.

### CROSS REFERENCE TO RELATED APPLICATIONS

This application is based on Korea Patent Application No. 2003-52519 filed on Jul. 30, 2003 in the Korean Intellectual Property Office, the content of which is incorporated herein by reference.

### BACKGROUND OF THE INVENTION

(a) Field of the Invention

The present invention relates to a device and method for driving a plasma display panel (PDP), and a plasma display device. More specifically, the present invention relates to an energy recovery circuit of the PDP.

(b) Description of the Related Art

A PDP is a flat panel display that uses plasma generated by gas discharge to display characters or images. It includes, depending on its size, more than several scores to millions of pixels arranged in a matrix pattern. A PDP is classified as a direct current (DC) type or an alternating current (AC) type according to its discharge cell structure and the waveform of the driving voltage applied thereto.

The DC PDP has electrodes exposed to a discharge space to allow current to flow through the discharge space while the voltage is applied, and thus requires a resistance for limiting the current. On the other hand, the AC PDP has electrodes covered with a dielectric layer that forms a capacitor to limit the current and protect the electrodes from the impact of ions during discharge. Thus, the AC PDP has a longer lifetime than the DC PDP.

FIG. 1 is a partial perspective view of an AC PDP.

Referring to FIG. 1, on a first glass substrate 1 a plurality of pairs of scan electrodes 4 and sustain electrodes 5 are arranged in parallel and are covered with a dielectric layer 2 and a protective layer 3. On a second glass substrate 6 a plurality of address electrodes 8 covered with an insulating layer 7 are arranged. Barrier ribs 9 are formed in parallel with the address electrodes 8 on the insulating layer 7, which is interposed between the address electrodes 8. A fluorescent material 10 is formed on the surface of the insulating layer 7 and on both sides of the barrier ribs 9. The first and second glass substrates 1 and 6 are arranged face-to-face with a discharge space 11 formed therebetween, and the scan electrodes 4 and the sustain electrodes 5 lie normal to the address electrodes 8. The discharge space at the intersection between the address electrode 8 and the pair of scan electrode 4 and sustain electrode 5 forms a discharge cell 12.

FIG. 2 shows an arrangement of electrodes in the PDP.

Referring to FIG. 2, the PDP has a pixel matrix consisting of m×n discharge cells. In the PDP, address electrodes A₁ to Aₘ are arranged in columns, and scan electrodes Y₁ to Yₙ and sustain electrodes X₁ to Xₙ are alternately arranged in rows. Discharge cells 12 shown in FIG. 2 correspond to the discharge cells 12 in FIG. 1.

The method for driving the AC PDP includes a reset period, an addressing period, a sustain period, and an erase period in temporal sequence.

The reset period is for initiating the status of each cell so as to facilitate the addressing operation. The addressing period is for selecting turn-on/off cells and applying an address voltage to the turn-on cells (i.e., addressed cells) to accumulate wall charges. The sustain period is for applying sustain pulses and causing a sustain-discharge for displaying an image on the addressed cells. The erase period is for reducing the wall charges of the cells to terminate the sustain-discharge.

The discharge spaces between the scan and sustain electrodes and between the address electrode side and the scan/sustain electrode side act as a capacitance load (hereinafter, referred to as “panel capacitor”), so capacitance exists on the panel. Due to the capacitance of the panel capacitor, reactive power is needed to apply a waveform for the sustain-discharge. Thus the PDP driver circuit includes a power recovery circuit for recovering the reactive power and reusing it, some of said power recovery circuit having been elucidated by L. F. Weber in U.S. Pat. Nos. 4,866,349 and 5,081,400.

The circuit designed by Weber repeatedly transfers energy from the panel to a power recovery capacitor or energy from the power recovery capacitor to the panel using a resonance between the panel capacitor and an inductor, thus recovering the effective power. In this circuit, however, the rise/fall time of the panel voltage is dependent upon the time constant LC determined by the inductance L of the inductor and the capacitance C of the panel capacitor. The rise time of the panel voltage is equal to the fall time because LC is constant. For a faster panel voltage rise time, the switch coupled to the power source must be hard-switched during the rise of the panel voltage, in which case stress on the switch increases. The hard-switching operation also causes a power loss and increases the effect of electromagnetic interference (EMI).

### SUMMARY OF THE INVENTION

It is an advantage of the present invention to provide a device and method for driving a PDP where said device and method allows zero-voltage switching despite the parasitic components of the actual circuit.

It is another object of the present invention to provide a device and method for driving a PDP where said device and method allow a stable discharge.

In one aspect of the present invention, a device for driving a plasma display panel, which has first and second electrodes with a panel capacitor formed therebetween, comprises:
a charge/discharge unit comprising a first inductor coupled to the first electrode, the charge/discharge unit changing the voltage of the first electrode from a first voltage to a second voltage by using the first inductor; and
a sustain unit maintaining the voltage of the first electrode at the second voltage during a predetermined period after the voltage of the first electrode is changed to the second voltage,
wherein the charge/discharge unit changes the voltage of the first electrode from the first voltage to a third voltage while increasing the magnitude of a current flowing in the first inductor, and changes the voltage of the first electrode from the third voltage to the second voltage while decreasing the magnitude of the current flowing in the first inductor; and
the third voltage is between a fourth voltage, corresponding to the mean value of the first and second voltages, and the second voltage.

In another aspect of the present invention, a method for driving a plasma display panel, which has first and second electrodes with a panel capacitor formed therebetween, comprises:
charging the panel capacitor to a first voltage, while increasing the magnitude of a current flowing in a first inductor coupled to the first electrode; and
changing the voltage of the panel capacitor from the first voltage to a second voltage, while decreasing the magnitude of the current flowing in the first inductor,
wherein the first voltage is between a third voltage, which corresponds to half of the second voltage, and the second voltage.

In still another aspect of the present invention, a method for driving a plasma display panel, which has first and second electrodes with a panel capacitor formed therebetween, comprises:
injecting a current of a first direction to a first inductor coupled to the first electrode to store a first energy, while the voltage of the first electrode and the voltage of the second electrode are both maintained at a first voltage;
changing the voltage of the first electrode to a second voltage by using a resonance between the first inductor and the panel capacitor and the first energy, while the voltage of the second electrode is maintained at the first voltage; and
maintaining the voltage of the first electrode at the second voltage and the voltage of the second electrode at the first voltage,
wherein the voltage of the first electrode is firstly changed from the first voltage to a third voltage while increasing the magnitude of a current flowing in the first inductor, and secondly changed from the third voltage to the second voltage while decreasing the magnitude of the current flowing in the first inductor, where the third voltage is between a fourth voltage, which corresponds to the mean value of the first and second voltages, and the second voltage.

In yet another aspect of the present invention, a method for driving a plasma display panel, which has first and second electrodes with a panel capacitor formed therebetween, comprises:
injecting a current of a first direction to a first inductor coupled to the first electrode to store a first energy, and injecting a current of a second direction to a second inductor coupled to the second electrode to store a second energy;
changing the voltage of the first electrode from a first voltage to a second voltage and the voltage of the second electrode from the second voltage to the first voltage by using a resonance between the first and second inductors and the panel capacitor and the first and second energies; and
maintaining the voltage of the first electrode at the second voltage and the voltage of the second electrode at the first voltage,
wherein the voltage of the first electrode is firstly changed from the first voltage to a third voltage while increasing the magnitude of a current flowing in the first inductor, and secondly changed from the third voltage to the second voltage while decreasing the magnitude of the current flowing in the first inductor, where the third voltage is between a fourth voltage, which corresponds to the mean value of the first and second voltages, and the second voltage.

In still another aspect of the present invention, a plasma display device comprises:
a plasma display panel having first and second electrodes with a panel capacitor formed therebetween; and
a driving circuit comprising an inductor coupled to the first electrode, the driving circuit applying a driving voltage to the first electrode,
wherein the driving circuit firstly charges the panel capacitor to a voltage greater than half of a desired voltage while increasing the magnitude of a current flowing in the inductor, and secondly charges the panel capacitor to the desired voltage while decreasing the magnitude of the current flowing in the inductor.

In yet another aspect of the present invention, a plasma display device comprises:
a plasma display panel having first and second electrodes with a panel capacitor formed therebetween; and
a driving circuit comprising first and second inductors coupled to the first electrode in parallel, the driving circuit applying a driving voltage to the first electrode,
wherein the driving circuit firstly charges the panel capacitor to a voltage greater than half of a desired voltage while increasing the magnitude of a current flowing in the first inductor, and secondly charges the panel capacitor to the desired voltage while decreasing the magnitude of the current flowing in the first inductor; and
the driving circuit discharges the panel capacitor by using the second inductor.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a partial perspective view of an AC PDP.

FIG. 2 shows an arrangement of electrodes in the AC PDP.

FIG. 3 is a schematic block diagram of a plasma display device according to an embodiment of the present invention.

FIG. 4 is a schematic circuit diagram of an energy recovery circuit according to a first embodiment of the present invention.

FIG. 5 is a timing diagram of the energy recovery circuit according to the first embodiment of the present invention.

FIGS. 6A to 6H are circuit diagrams showing the current path of each mode in the energy recovery circuit according to the first embodiment of the present invention.

FIG. 7 is a diagram of a discharge current and a charge current of the capacitor in the energy recovery circuit according to the first embodiment of the present invention.

FIG. 8 is an equivalent circuit diagram of mode 2 in the energy recovery circuit according to the first embodiment of the present invention.

FIG. 9 is a diagram showing the wall charge status in a discharge cell.

FIG. 10 is a timing diagram of the energy recovery circuit according to a second embodiment of the present invention.

FIG. 11 is a schematic circuit diagram of an energy recovery circuit according to a third embodiment of the present invention.

FIG. 12 is a timing diagram of the energy recovery circuit according to the third embodiment of the present invention.

FIGS. 13A to 13H are circuit diagrams showing the current path of each mode in the energy recovery circuit according to the third embodiment of the present invention.

FIG. 14 is a schematic circuit diagram of an energy recovery circuit according to a fourth embodiment of the present invention.

FIG. 15 is a timing diagram of an energy recovery circuit according to a fifth embodiment of the present invention.

FIGS. 16A to 16H are circuit diagrams showing the current path of each mode in the energy recovery circuit according to the fifth embodiment of the present invention.

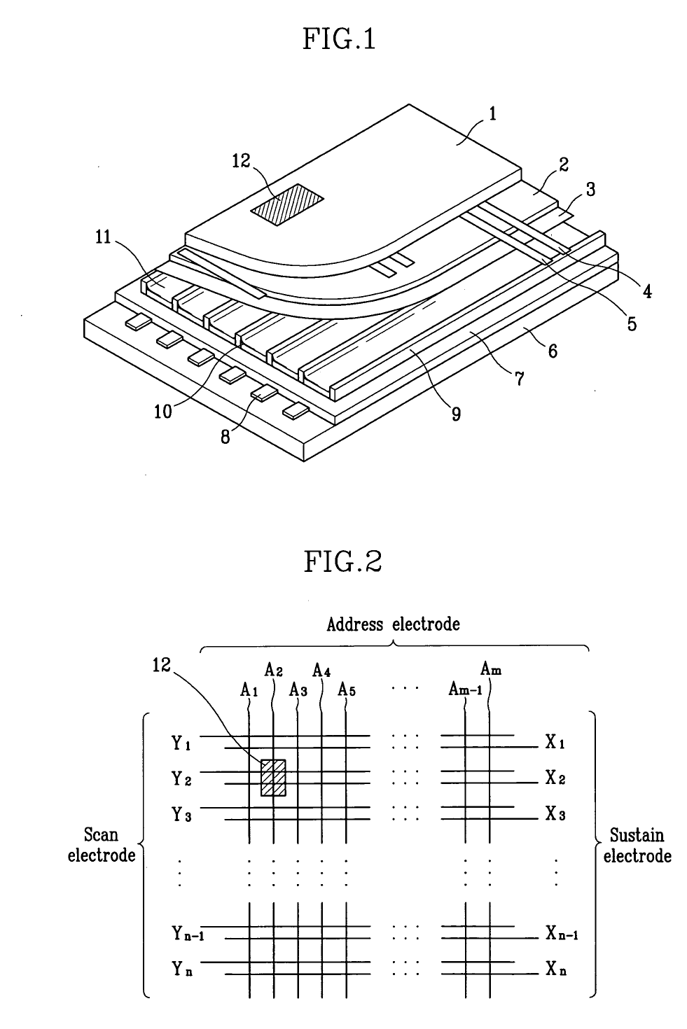

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

Hereinafter, a device and method for driving a PDP, and a plasma display device according to an embodiment of the present invention, will be described in detail with reference to the accompanying drawings.

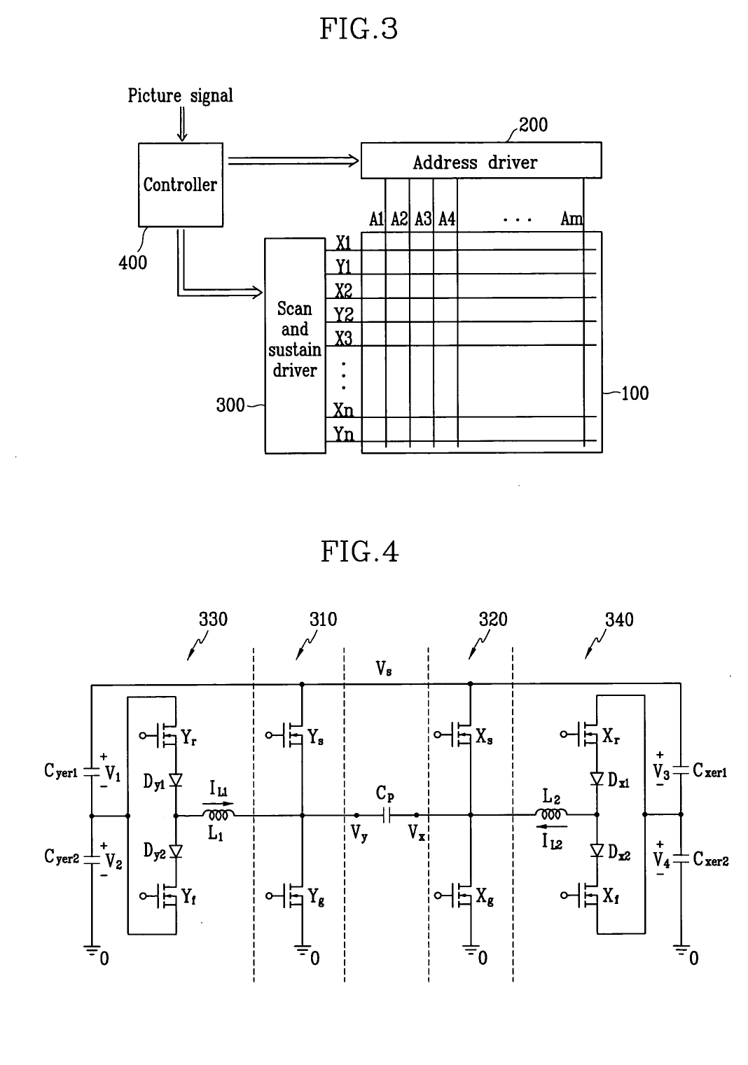

FIG. 3 is a schematic block diagram of a plasma display device according to the embodiment of the present invention.

The plasma display device according to the embodiment of the present invention comprises, as shown in FIG. 3, a plasma display panel 100, an address driver 200, a scan/sustain driver 300, and a controller 400.

The plasma display panel 100 comprises a plurality of address electrodes A₁ to Aₘ arranged in columns, a plurality of scan electrodes Y₁ to Yₙ (hereinafter referred to as “Y electrodes”) and a plurality of sustain electrodes X₁ to Xₙ (hereinafter referred to as “X electrodes”) alternately arranged in rows. The X electrodes X₁ to Xₙ are formed in correspondence to the Y electrodes Y₁ to Yₙ respectively. One terminal of each X electrode is connected to a terminal of each Y electrode. The controller 400 receives an external picture signal, generates an address drive control signal and a sustain control signal, and applies the generated control signals to the address driver 200 and the scan/sustain driver 300, respectively.

The address driver 200 receives the address drive control signal from the controller 400, and applies a display data signal to each address electrode to select the discharge cells to be displayed. The scan/sustain driver 300 receives the sustain control signal from the controller 400, and applies sustain pulses alternately to the Y and X electrodes. The applied sustain pulses cause a sustain-discharge on the selected discharge cells.

Next, the energy recovery circuit of the scan/sustain driver 300 according to a first embodiment of the present invention will be described in detail with reference to FIG. 4.

FIG. 4 is a schematic circuit diagram of an energy recovery circuit according to the first embodiment of the present invention.

The energy recovery circuit according to the first embodiment of the present invention comprises, as shown in FIG. 4, a Y electrode sustain unit 310, an X electrode sustain unit 320, a Y electrode charge/discharge unit 330, and an X electrode charge/discharge unit 340.

The Y electrode sustain unit 310 is connected to the X electrode sustain unit 320, and a panel capacitor Cₚ is connected between the Y electrode sustain unit 310 and the X electrode sustain unit 320. The Y electrode sustain unit 310 includes switches Yₛ and Y_{g}, and the X electrode sustain unit 320 includes switches Xₛ and X_{g}. The Y electrode charge/discharge unit 330 includes an inductor L₁, switches Yᵣ and Y_{f}, and energy recovery capacitors C_{yer1} and C_{yer2}, and the X electrode charge/discharge unit 340 includes an inductor L₂, switches Xᵣ and X_{f}, and energy recovery capacitors Cₓₑᵣ₁ and Cₓₑᵣ₂. These switches Yₛ, Yₛ, Y_{g}, Xₛ, X_{g}, Yᵣ, Y_{f}, Xᵣ, and X_{f} are preferably MOSFETs having a body diode, but may be any other switches that satisfy the following functions.

Switches Yₛ, and Y_{g} are connected in series between a sustain discharge voltage Vₛ and a ground voltage 0V, and switches Xₛ and X_{g} are connected in series between a sustain discharge voltage Vₛ and a ground voltage 0V. The contact of switches Yₛ, and Y_{g} is connected to the Y electrode of panel capacitor Cₚ, and the contact of switches Xₛ and X_{g} is connected to the X electrode of panel capacitor Cₚ.

The switching operations of these four switches Yₛ, Y_{g}, Xₛ, and X_{g} allow the Y and X electrode voltages V_{y} and Vₓ of panel capacitor Cₚ to be maintained at either the sustain discharge voltage Vₛ or the ground voltage.

One terminal of inductor L₁ is connected to the Y electrode of panel capacitor Cₚ, and switches Yᵣ and Y_{f} are connected in parallel between the other terminal of inductor L₁ and a contact of energy recovery capacitors C_{yer1} and C_{yer2}. The Y electrode charge/discharge unit 330 may further include diodes D_{y1} and D_{y2} for preventing a current path possibly formed by the body diodes of switches Yᵣ and Y_{f}. The Y electrode charge/discharge unit 330 charges the Y electrodes of the panel capacitor to the sustain discharge voltage Vₛ or discharges such voltage to the ground voltage.

Likewise, one terminal of inductor L₂ is connected to the X electrode of panel capacitor Cₚ, and switches Xᵣ and X_{f} are connected in parallel between the other terminal of inductor L₂ and a contact of the energy recovery capacitors Cₓₑᵣ₁ and Cₓₑᵣ₂. The X electrode charge/discharge unit 340 may further include diodes Dₓ₁ and Dₓ₂ for preventing a current path possibly formed by the body diodes of switches Xᵣ and X_{f}. The X electrode charge/discharge unit 340 charges the X electrodes of the panel capacitor to the sustain discharge voltage Vₛ or discharges such voltage to the ground voltage.

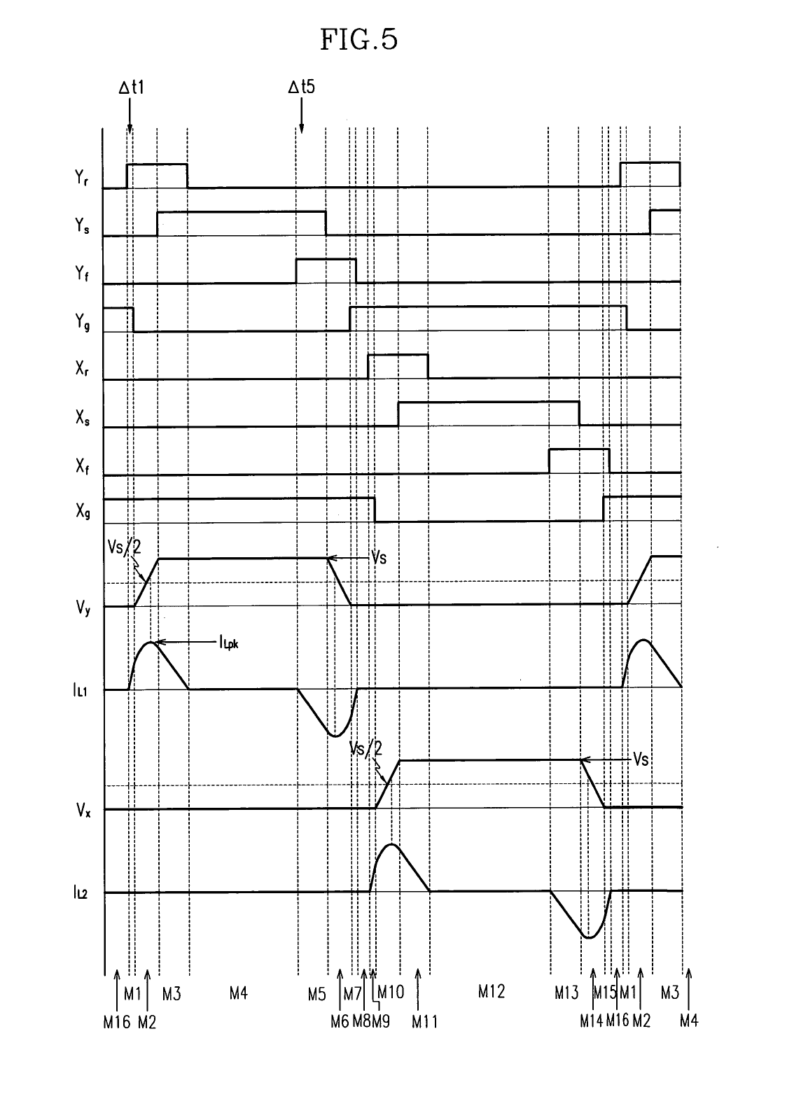

Next, the sequential operation of the energy recovery circuit according to the first embodiment of the present invention will be described with reference to FIGS. 5, 6A to 6H, 7, 8, and 9. Here, the operation proceeds in the order of 16 modes, which arise through the manipulation of switches. The phenomenon called “resonance” herein is not a continuous oscillation but a variation of voltage and current caused by inductor L₁ or L₂ and panel capacitor Cₚ, when switch Yᵣ, Y_{f}, Xᵣ or X_{f} is turned on.

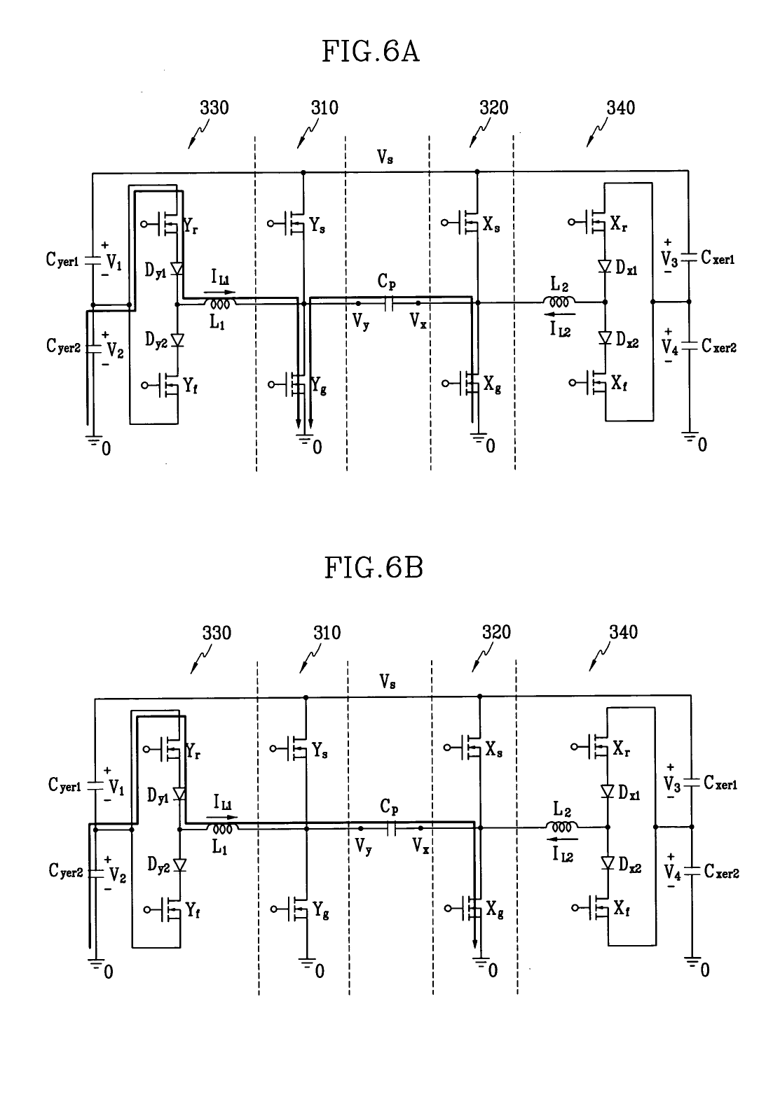

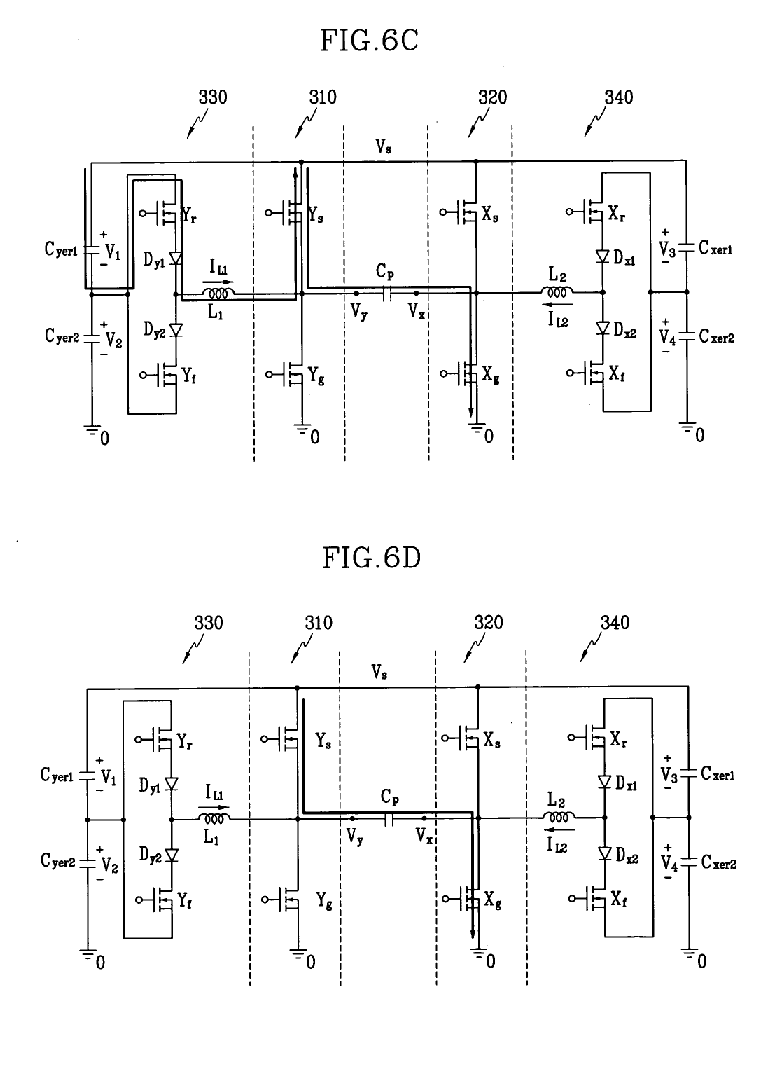

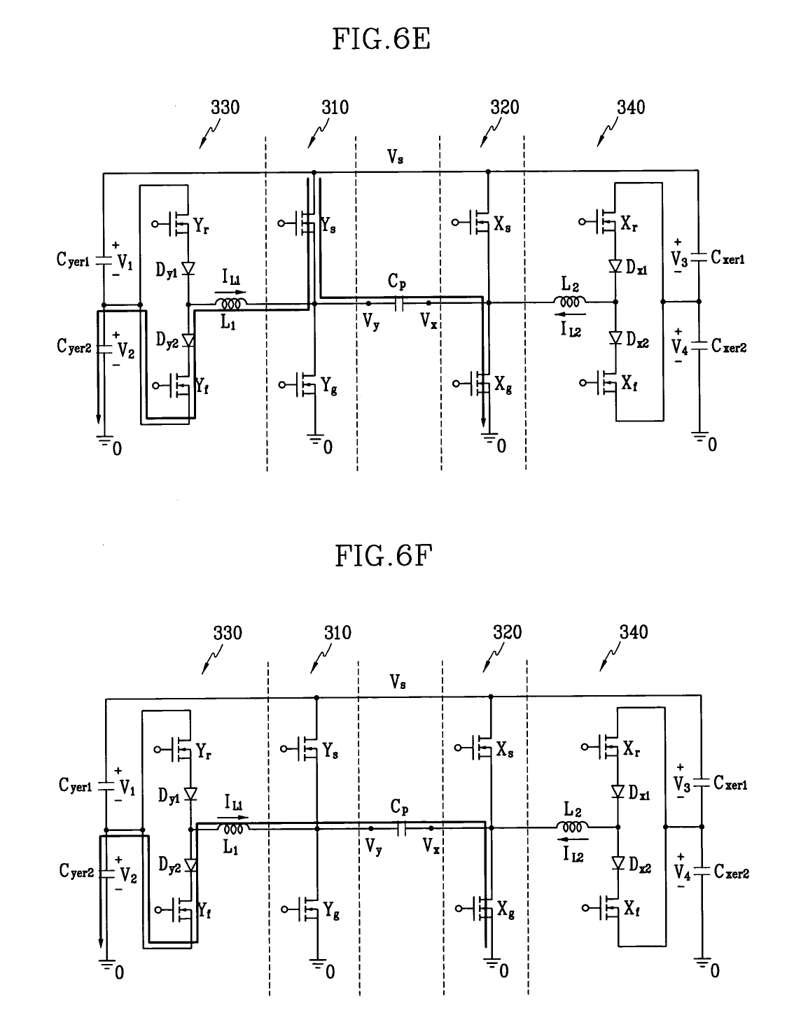

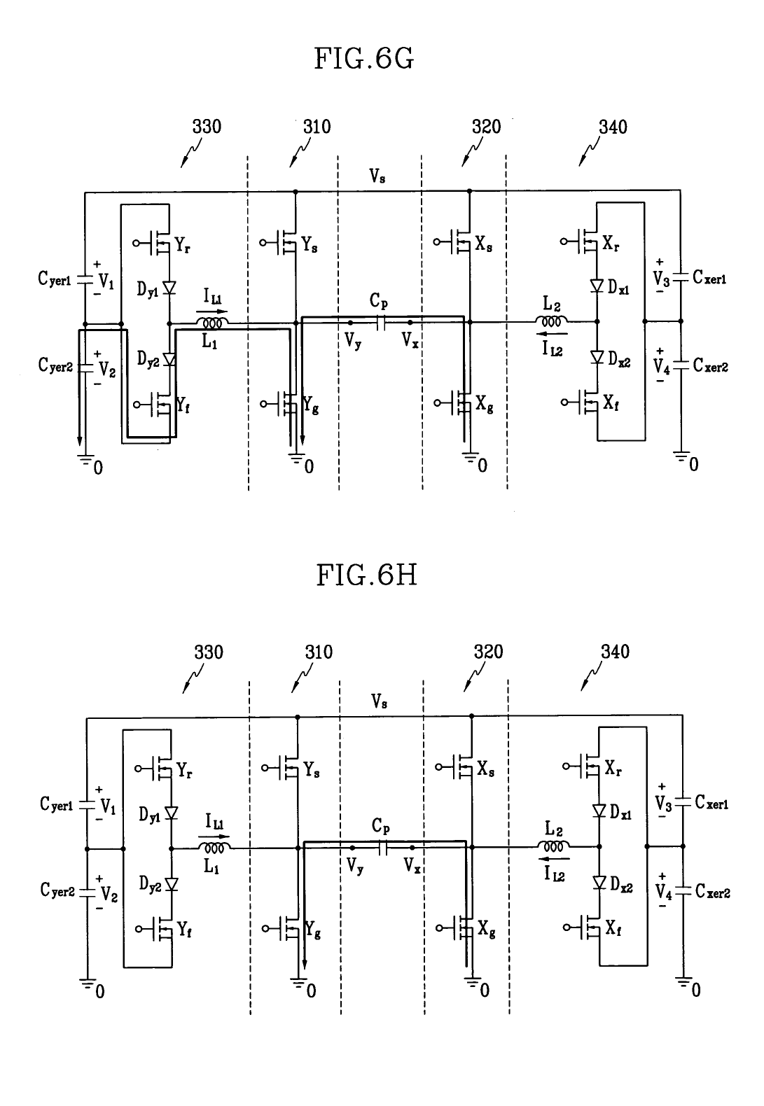

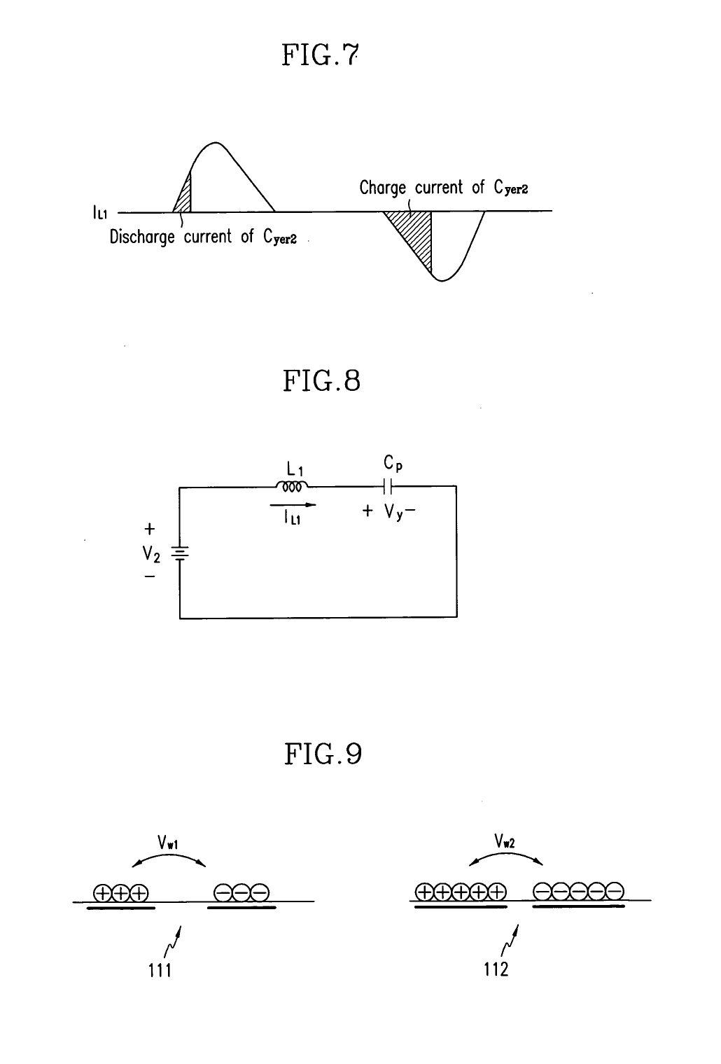

FIG. 5 is a timing diagram of the energy recovery circuit according to the first embodiment of the present invention. FIGS. 6A to 6H are circuit diagrams showing the current path of each mode in the energy recovery circuit according to the first embodiment of the present invention. FIG. 7 is a diagram of a discharge current and a charge current of the capacitor in the energy recovery circuit according to the first embodiment of the present invention. FIG. 8 is an equivalent circuit diagram of mode 2 in the energy recovery circuit according to the first embodiment of the present invention. FIG. 9 is a diagram showing the wall charge status in a discharge cell.

According to the first embodiment of the present invention, prior to the operation, switches Y_{g} and X_{g} are in the “ON” state, so that the Y and X electrode voltages V_{y} and Vₓ of panel capacitor Cₚ are both maintained at 0V. Capacitors C_{yer1}, C_{yer2}, Cₓₑᵣ₁, and Cₓₑᵣ₂ are respectively charged with voltages V₁, V₂, V₃, and V₄.

Mode 1

In mode 1, as illustrated in FIGS. 5 and 6A, switch Yᵣ is turned ON, with switches Y_{g} and X_{g} in the “ON” state. Then, a current I_{L1} flowing to inductor L₁ is increased with a slope of Vₛ/2L₁ by a current path that includes capacitor C_{yer2}, switch Yᵣ, inductor L₁, and switch Y_{g} in sequence. Energy is thus stored (charged) in inductor L₁.

Mode 2

In mode 2, as illustrated in FIGS. 5 and 6B, switch Y_{g} is turned OFF, with switches Yᵣ and X_{g} in the “ON” state. Then, a current path is formed that includes capacitor C_{yer2}, switch Yᵣ, inductor L₁, panel capacitor Cₚ, and switch X_{g} in sequence, thereby causing an LC resonance. Due to the resonance, the Y electrode voltage V_{y} of panel capacitor Cₚ is increased and panel capacitor Cₚ is charged.

Because energy is stored in inductor L₁ in mode 1, it is possible to increase the Y electrode voltage V_{y} to a sustain-discharge voltage Vₛ even when a parasitic component exists in the energy recovery circuit.

Mode 3)

In mode 3, as illustrated in FIGS. 5 and 6C, switch Yₛ is turned ON when the Y electrode voltage V_{y} has increased to Vₛ.

The Y electrode voltage V_{y} cannot exceed Vₛ due to the body diode of the switch Yₛ. The body diode of the switch Yₛ is automatically turned ON when the Y electrode V_{y} equals Vₛ. At this time, switch Yₛ (a channel of switch Yₛ) is also turned ON. Accordingly, switch Yₛ is turned ON when the voltage between the drain and source is zero. In other words, with zero-voltage switching, there is no turn-on switching loss.

When switch Yₛ is turned ON, the Y electrode voltage V_{y} is maintained at the sustain-discharge voltage Vₛ. Accordingly, the voltage across the terminals of panel capacitor Cₚ (V_{y}-Vₓ) (hereinafter referred to, as “panel voltage”) is maintained at the sustain-discharge voltage Vₛ so that discharge occurs.

In addition, the magnitude of current I_{L1} flowing to inductor L₁ is decreased to 0A on the current path through switch Yᵣ, inductor L₁, the body diode of switch Y₅, and capacitor C_{yer1} in sequence. Namely, the energy stored in inductor L₁ is recovered to capacitor C_{yer1}.

Mode 4

Referring to FIGS. 5 and 6D, in mode 4, switch Yᵣ is turned OFF after current I_{L1} flowing to inductor L₁ becomes 0A. With switches Yₛ and X_{g} in the “ON” state, the Y and X electrode voltages V_{y} and Vₓ of panel capacitor Cₚ are maintained at Vₛ and 0V, respectively.

Mode 5

In mode 5, as illustrated in FIGS. 5 and 6E, switch Y_{f} is turned ON with switches Yₛ and X_{g} in the “ON” state. Then, a current path is formed through switch Yₛ, inductor L₁, switch Y_{f}, and capacitor C_{yer2} in sequence. Then, current I_{L1} flowing to inductor L₁ is decreased (i.e., the magnitude of current I_{L1} is increased), and energy is stored in inductor L₁.

Mode 6)

In mode 6, as illustrated in FIGS. 5 and 6F, switch Yₛ is turned OFF to form a current path through the body diode of switch X_{g}, panel capacitor Cₚ, inductor L₁, switch Y_{f}, and capacitor C_{yer2} in sequence, thereby causing an LC resonance. Due to the LC resonance, the Y electrode voltage V_{y} of panel capacitor Cₚ is decreased and the panel capacitor is discharged.

Mode 7

In mode 7, as illustrated in FIGS. 5 and 6G, switch Y_{g} is turned ON when the Y electrode voltage V_{y} is decreased to 0.

The Y electrode voltage V_{y} cannot exceed 0V due to the body diode of switch Y_{g}. The body diode of switch Y_{g} is automatically turned ON when the Y electrode voltage V_{y} equals 0V. At this time, switch Y_{g} (a channel of switch Y_{g}) is also turned ON. Accordingly, switch Y_{g} is turned ON when the voltage between the drain and source is zero. In other words, with zero-voltage switching, there is no turn-on switching loss. When switch Y_{g} is turned ON, the Y electrode voltage V_{y} is maintained at 0V.

In addition, current I_{L1} flowing to inductor L₁ is increased (i.e., the magnitude of current I_{L1} is decreased) on the current path through the body diode of switch Y_{g}, inductor L₁, switch Y_{f}, and capacitor C_{yer2} in sequence, and the energy stored in inductor L₁ is recovered to capacitor C_{yer2}.

Mode 8

Referring to FIGS. 5 and 6H, in mode 8, switch Y_{f} is turned OFF after current I_{L1} flowing to inductor L₁ becomes 0A. With switches Y_{g} and X_{g} in the “ON” state, the Y and X electrode voltages V_{y} and Vₓ of panel capacitor Cₚ are both maintained at 0V.

In modes 1 through 8, the panel voltage (V_{y}-Vₓ) swings between 0V and Vₛ. As illustrated in FIG. 5, switches Xₛ, X_{g}, Xᵣ, and X_{f} and switches Yₛ, Y_{g}, Yᵣ, and Y_{f} in modes 9 through 16 operate in the same manner as switches Yₛ, Y_{g}, Yᵣ, and Y_{f} and switches Xₛ, X_{g}, Xᵣ, and X_{f} operate in modes 1 through 8, respectively. The X electrode voltage Vₓ of panel capacitor Cₚ in modes 9 through 16 has the same waveform as the Y electrode voltage V_{y} has in modes 1 through 8. Hence, the panel voltage V_{y}-Vₓ in modes 9 through 16 swings between 0V and −Vₛ. The operation of the energy recovery circuit according to the first embodiment of the present invention in modes 9 through 16 will be understood by those skilled in the art and will not be described in detail.

As shown in FIGS. 5 and 7, in the first embodiment, period Δt₁ of mode 1, which is the period during which switches Yᵣ and Y_{g} are both turned ON, is shorter than period Δt₅ of mode 5, which is the period during which switches Yₛ and Y_{f} are both turned ON, so that voltage V₂ of capacitor C_{yer2} becomes greater than voltage V₁ of capacitor C_{yer1}. Then, as illustrated in FIG. 7, the discharge current (i.e., energy) of capacitor C_{yer2} becomes less than the charge current (i.e., energy) of capacitor C_{yer2}. In the steady state, voltage V₂ of capacitor C_{yer2} remains at a level that is greater than voltage V₁ of capacitor C_{yer1}, which equals Vₛ/2.

The circuit state in mode 2 is modeled as shown in FIG. 8 by assuming that current I_{L1} flowing to inductor L₁ is Iₚ₁ at the time mode 1 ends, and capacitor C_{yer2} is a power source supplying V₂. In FIG. 8, current I_{L1} flowing to inductor L₁ and the Y electrode voltage V_{y} are given by Equations 1 and 2, respectively.

$$\begin{matrix}\begin{matrix}{I}_{L1} ( t ) = {I}_{p1} cos ω t + \sqrt{\frac{{C}_{p}}{{L}_{1}}} {V}_{2} sin ω t \\ = \sqrt{{I}_{p1}^{2} + \frac{{C}_{p}}{{L}_{1}} {V}_{2}^{2}} sin ( ω t + {θ}_{1} )\end{matrix} & [ Equation 1 ] \\ \begin{matrix}{V}_{y} ( t ) = {V}_{2} ( 1 - cos ω t ) + \sqrt{\frac{{L}_{1}}{{C}_{p}}} {I}_{p1} sin ω t \\ = {V}_{2} - \sqrt{{V}_{2}^{2} + \frac{{L}_{1}}{{C}_{p}} {I}_{p1}^{2}} cos ( ω t + {θ}_{1} )\end{matrix} & [ Equation 2 ]\end{matrix}$$

In the Equations 1 and 2, θ₁ and ω are given by Equations 3 and 4, respectively.

$$\begin{matrix}{θ}_{1} = {tan}^{- 1} \frac{\sqrt{\frac{{L}_{1}}{{C}_{p}}} {I}_{p1}}{{V}_{2}} & [ Equation 3 ] \\ ω = \frac{1}{\sqrt{{L}_{1} {C}_{p}}} & [ Equation 4 ]\end{matrix}$$

Referring to Equation 1, the magnitude of current I_{L1} reaches a maximum at time tₚₖ, which occurs when sin(ωt+θ₁) is 1, or, equivalently, when, ωt+θ₁) is π/2. At that time, the Y electrode voltage V_{y} is greater than Vₛ /2. According to Equation 2, it is possible to increase the Y electrode voltage V_{y} to the sustain-discharge voltage Vₛ even when a parasitic component exists in the energy recovery circuit. Therefore, switch Yₛ performs zero-voltage switching.

In addition, because the Y electrode voltage V_{y} is greater than Vₛ/2 when the magnitude of current I_{L1} of inductor L₁ reaches its peak, the Y electrode voltage V_{y} reaches the sustain-discharge voltage Vₛ a short time after the magnitude of current I_{L1} is maximum. Accordingly, the rise time of the Y electrode voltage (the panel voltage) shortens.

Also, as illustrated in FIG. 5, much current (energy) remains in inductor L₁ during the latter half of mode 2 when the Y electrode voltage V_{y} rises. When a discharge occurs during the rise of the panel voltage in accordance with the discharge cell state, the discharge cannot be sustained if the energy stored in inductor L₁ is insufficient. However, in the first embodiment of the present invention, the discharge current can be supplied from inductor L₁ because the energy stored in inductor L₁ is sufficient in mode 2. Accordingly, the discharge can be stably sustained to supply the sustain-discharge voltage Vₛ until switch Yₛ is turned ON in mode 3.

According to the first embodiment of the present invention, it is possible to increase the panel voltage to a sustain-discharge voltage Vₛ because voltage Vₛ of capacitor C_{yer2} is greater than Vₛ/2. Also the energy stored in inductor can be used in discharge. In addition, the Y electrode voltage and the X electrode voltage are changed in an independent manner according to the first embodiment.

In the first embodiment of the present invention, two capacitors C_{yer1} and C_{yer2} are used in the Y electrode charge/discharge unit 330. In a modification of this embodiment, capacitor C_{yer1} can be removed. In this time, the current can be recovered to the sustain-discharge voltage Vₛ in the mode 3. Also, a power source other than capacitor C_{yer2} can be used for supplying voltage V₂.

In addition, in the first embodiment of the present invention, the rise time and the fall time of the panel voltage can be different by controlling the periods of modes 1 and 5, which will now be described in detail.

For ease of description, it is assumed that current I_{L1} flowing to inductor L₁ is the same when mode 1 ends and when mode 5 ends. As described above, in mode 2 current I_{L1} and the Y electrode voltage are given by Equations 1 and 2. In mode 6, the Y electrode voltage V_{y} is given by Equation 5. In Equation 5, θ₂ is given by Equation 6.

$$\begin{matrix}{V}_{y} ( t ) = {V}_{s} - ( {V}_{s} - {V}_{2} ) + \sqrt{{( {V}_{s} - {V}_{2} )}^{2} + \frac{{L}_{1}}{{C}_{p}} {I}_{p1}^{2}} cos ( ω t + {θ}_{2} ) & [ Equation 5 ] \\ {θ}_{2} = {tan}^{- 1} \frac{\sqrt{\frac{{L}_{1}}{{C}_{p}}} {I}_{p1}}{{V}_{s} - {V}_{2}} & [ Equation 6 ]\end{matrix}$$

In this instance, the Y electrode voltage V_{y} becomes greater than Vₛ/2 when the magnitude of current I_{L1} of inductor L₁ reaches its peak, because (V₁-V₂) is less than Vₛ. Accordingly, the Y electrode voltage V_{y} becomes 0V a long time after the magnitude of current I_{L1} is at its maximum.

According to the first embodiment of the present invention, the rise time of the Y electrode voltage is shorter than the fall time of the Y electrode voltage.

The wall charge state of the regions between the X and Y electrodes of panel is capacitor Cₚ, i.e., the discharge cells, is not uniform, so the wall voltage differs for each discharge cell, as illustrated in FIG. 9. Where a small amount of wall charges accumulates, as in discharge cell 111, the wall voltage V_{W1} is low and the discharge firing voltage is high. Where a large amount of wall charges accumulates, as in discharge cell 112, the wall voltage V_{W2} is high, and the discharge firing voltage is low. If the wall voltage is high as in discharge cell 112, discharge can occur during the rise of the panel voltage.

Discharge begins during mode 2 in which switch Yₛ is in the “OFF” state, so that power for sustaining the discharge must be supplied from inductor L₁ as describe above. However, if the energy stored in inductor L₁ is not sufficient, the discharge that occurrs during the rise of the panel voltage is not sustained, and a second discharge occurs when switch Yₛ is turned ON. As discharge occurs twice, there is no uniform light emitted on the whole panel. Therefore, the rise time of the panel voltage is preferably short enough to prevent such a non-uniform discharge.

In addition, a rapid decrease of the panel voltage may cause self-erasing of the wall charges by movement of resonant charges due to the rapid change of the electric field, resulting in a non-uniform distribution of the wall charges among discharge cells. On the other hand, a slow decrease of the panel voltage lowers the wall voltage due to recombination of spatial charges, causing no self-erasing. As a result, the fall time of the panel voltage is preferably longer than the rise time.

As described above, in the first embodiment, voltage V₂ of capacitor C_{yer2} is greater than Vₛ/2 so that the rise time of the panel voltage is shorter than the fall time of the panel is voltage, thereby allowing a uniform light and a uniform wall charge state. The rise time and the fall time of the panel voltage can be controlled by controlling voltage V₂. In addition, for ease of description, it is assumed that current I_{L1} flowing to inductor L₁ is the same when mode 1 ends and when mode 5 ends. Even if both currents differ, the rise time and the fall time of the panel voltage can be controlled by controlling the voltage V₂.

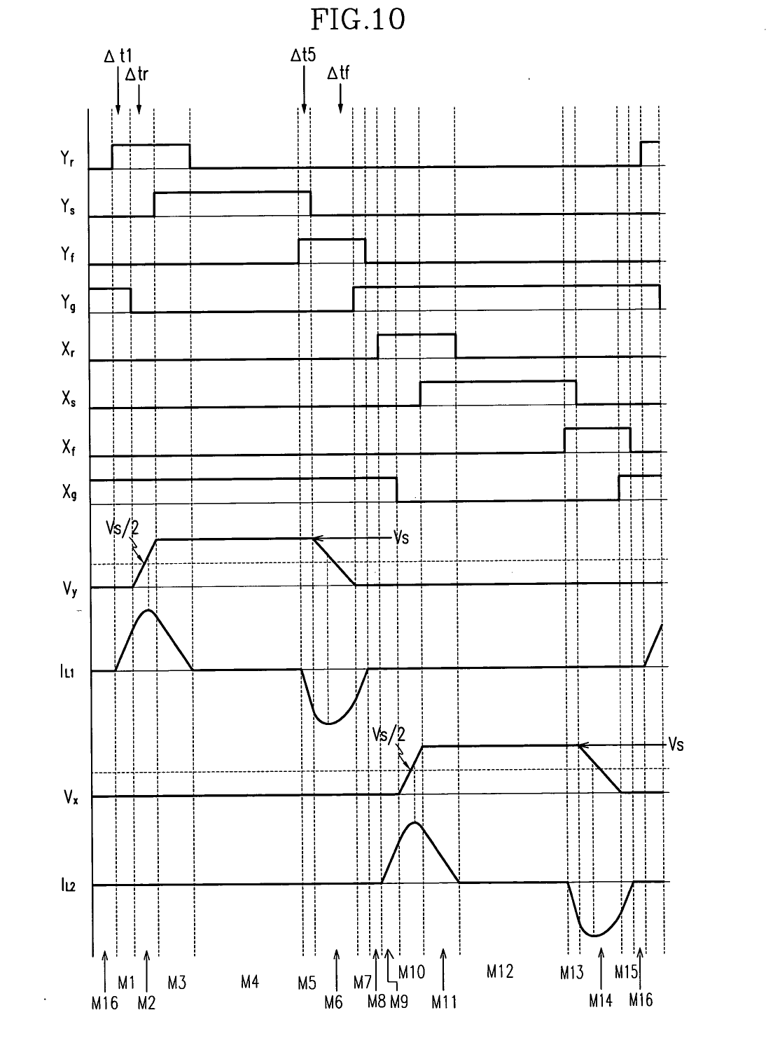

In addition, in a second embodiment of the present invention, the panel voltage can be controlled by controlling the period of modes 1 and 5. A second embodiment of the present invention will now be described in detail, referring to FIG. 10, which is a timing diagram of the energy recovery circuit according to a second embodiment of the present invention.

In the circuit of FIG. 4, a power source other than capacitor C_{yer2} for supplying voltage V₂ is connected to switches Yᵣ and Y_{f}. Then, current Iₚ₁ flowing to inductor L₁ when mode 1 ends and current Iₚ₅ flowing to inductor L₁ when mode 5 ends are given by Equations 7 and 8, respectively.

$$\begin{matrix}{I}_{p1} = \frac{{V}_{2}}{{L}_{1}} Δ {t}_{1} & [ Equation 7 ] \\ {I}_{p5} = \frac{{V}_{s} - {V}_{2}}{{L}_{1}} Δ {t}_{5} & [ Equation 8 ]\end{matrix}$$

In the second embodiment, time Δt₁ of mode 1 is longer than time Δt₅ of mode 5. As a result, current Iₚ₁ becomes greater than current Iₚ₅ because voltage V₂ is greater than voltage (V₁-V₂). From Equation 2, the time Δtᵣ of mode 2, which is the rise time of the panel voltage, is given by Equation 9. Likewise, the time Δt_{f} of mode 6, which is the fall time of the panel voltage, is given by Equation 10.

$$\begin{matrix}Δ {t}_{r} = \sqrt{{L}_{1} {C}_{p}} [ {cos}^{- 1} ( - \frac{{V}_{s} - {V}_{2}}{\sqrt{{V}_{2}^{2} + {( {I}_{p1} \sqrt{{L}_{1} / {C}_{p}} )}^{2}}} ) - {tan}^{- 1} \frac{{I}_{p1} \sqrt{{L}_{1} / {C}_{p}}}{{V}_{2}} ] & [ Equation 9 ] \\ Δ {t}_{f} = \sqrt{{L}_{1} {C}_{p}} [ {cos}^{- 1} ( - \frac{{V}_{2}}{\sqrt{{( {V}_{s} - {V}_{2} )}^{2} + {( {I}_{p5} \sqrt{{L}_{1} / {C}_{p}} )}^{2}}} ) - {tan}^{- 1} \frac{{I}_{p5} \sqrt{{L}_{1} / {C}_{p}}}{{V}_{s} - {V}_{2}} ] & [ Equation 10 ]\end{matrix}$$

The rise time of the panel voltage is shorter than the fall time of the panel voltage because current Iₚ₁ is greater than current Iₚ₅ and voltage V₂ is greater than voltage (V₁-V₂). In addition, the Y electrode voltage V_{y} is greater than Vₛ/2 when the magnitude of current I_{L1} Of inductor L₁ is at a maximum.

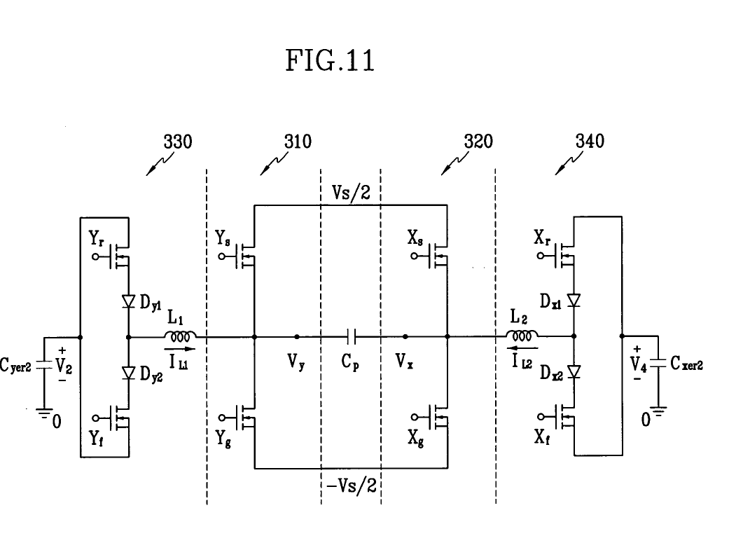

In the first and second embodiments of the present invention, the sustain-discharge voltage Vₛ and the ground voltage 0V are applied to the Y and X electrodes in turn. In a modification from these embodiments, Vₛ/2 and −Vₛ/2 can instead be applied to the Y and X electrodes in turn. A third embodiment of the present invention will now be described in detail, referring to FIGS. 11, 12, and 13A to 13H.

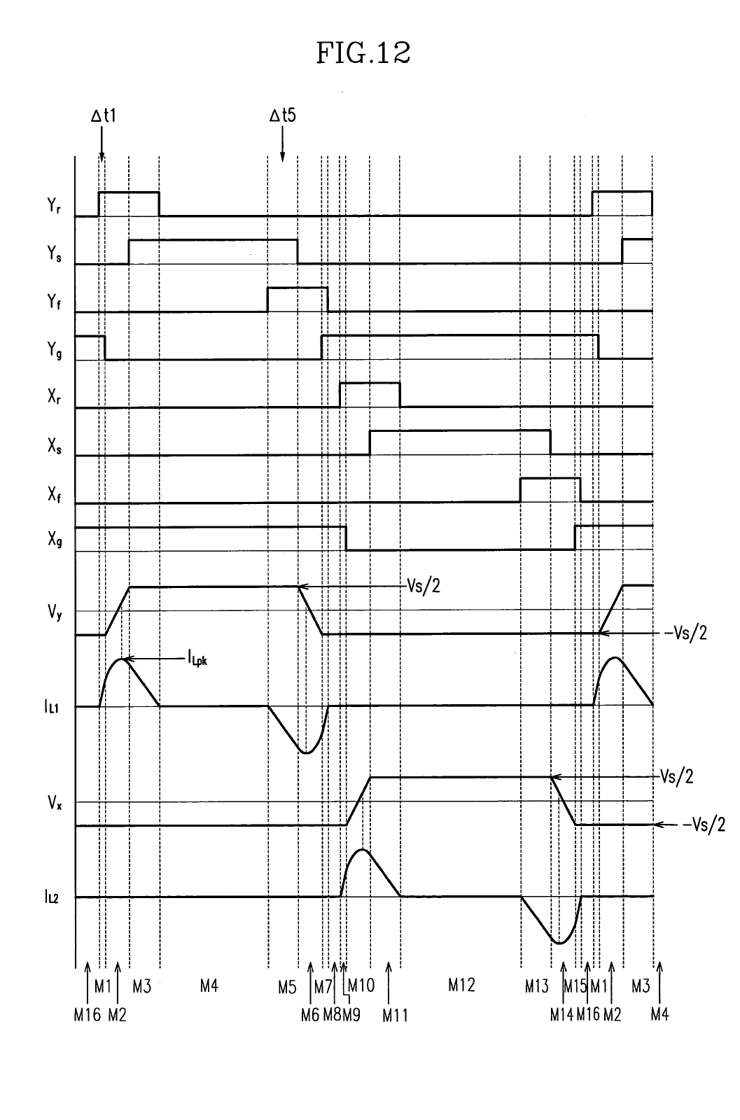

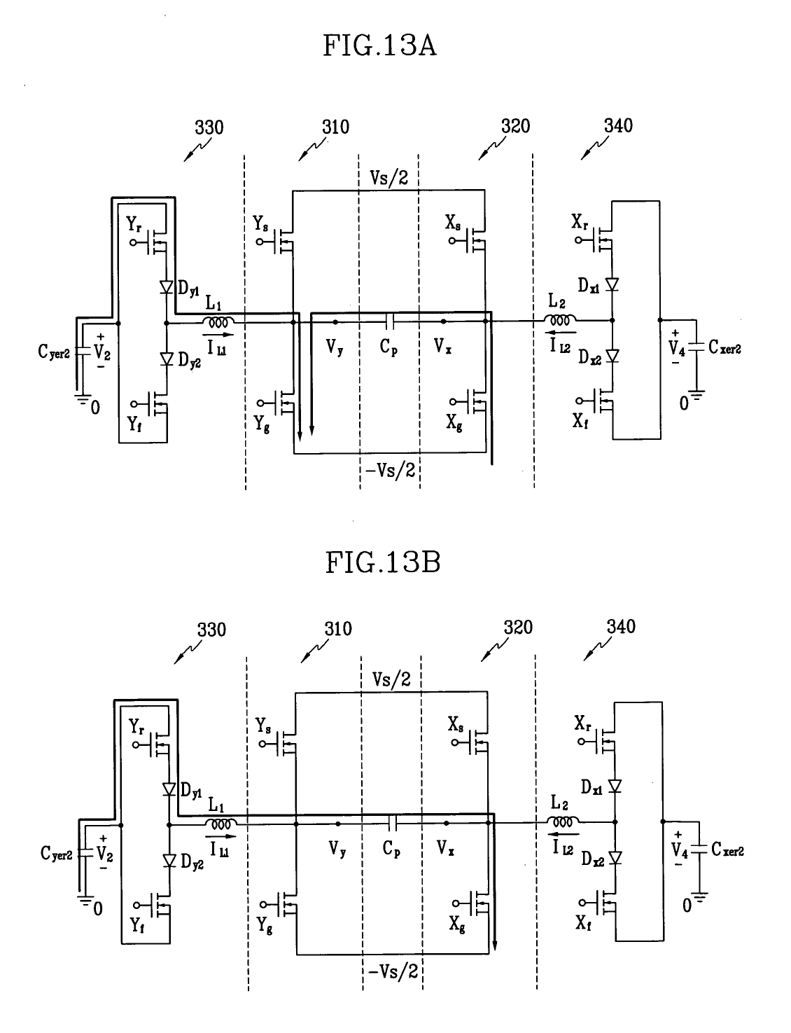

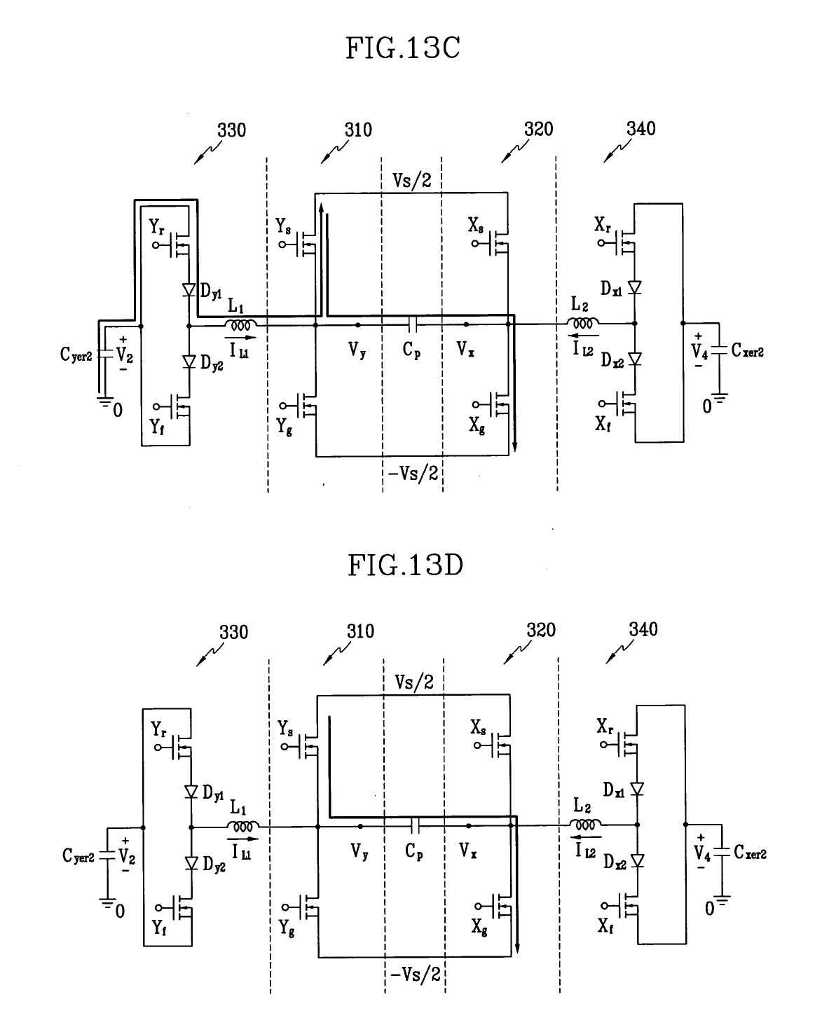

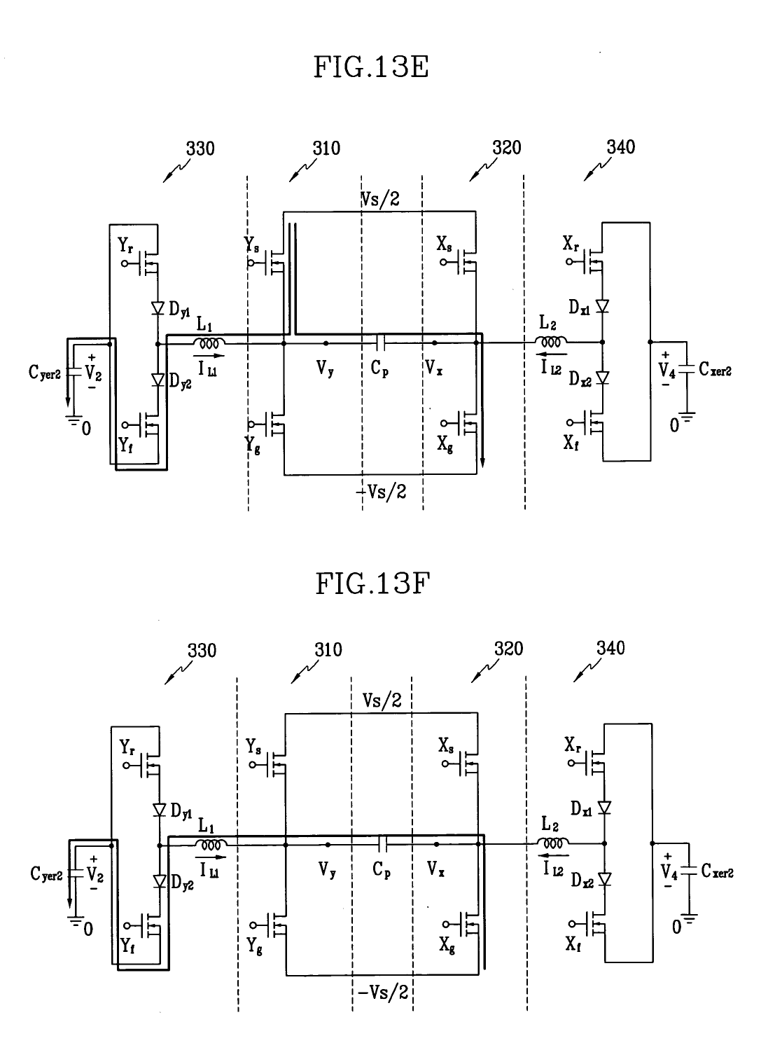

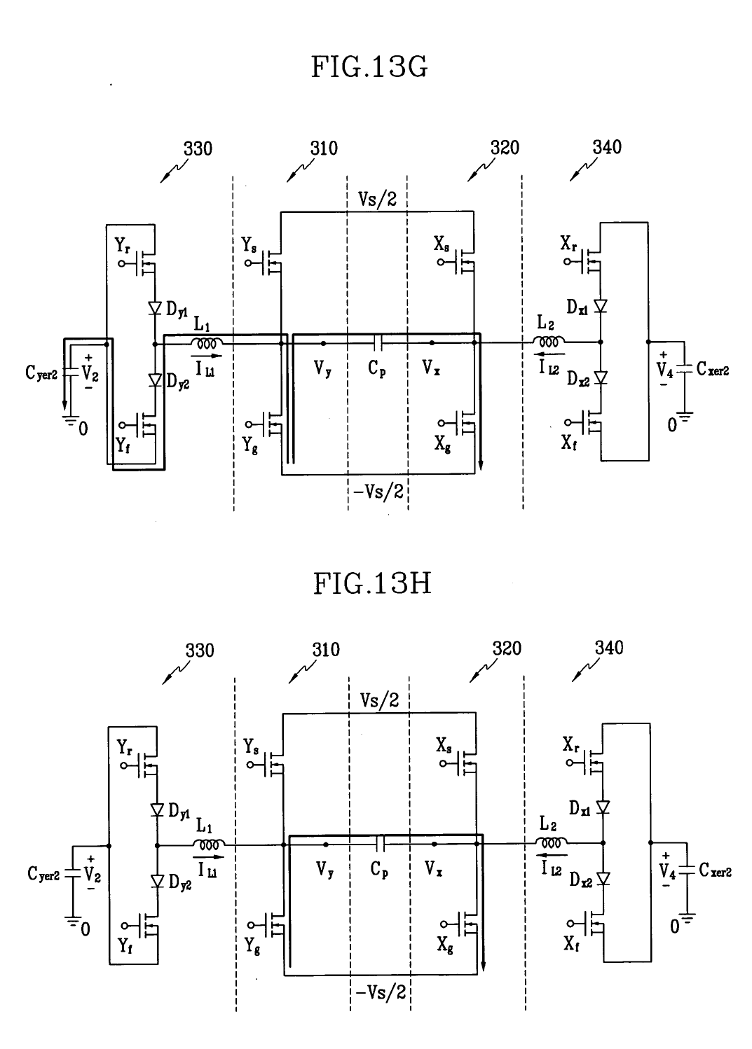

FIG. 11 is a schematic circuit diagram of an energy recovery circuit according to a third embodiment of the present invention. FIG. 12 is a timing diagram of the energy recovery circuit according to the third embodiment of the present invention. FIGS. 13A to 13H are circuit diagrams showing the current path of each mode in the energy recovery circuit according to the third embodiment of the present invention.

In the energy recovery circuit as shown in FIG. 11 and differing from the first preferred embodiment, switches Yₛ and Xₛ are connected to the voltage Vₛ/2 corresponding to half of the sustain-discharge voltage Vₛ, and switches Y_{g} and X_{g} are connected to the voltage −Vₛ/2. Switches Yᵣ and Y_{f} of the Y electrode charge/discharge unit 330 are connected to capacitor C_{yer2}, and switches Xᵣ and X_{f} of the X electrode charge/discharge unit 340 are connected to capacitor Cₓₑᵣ₂. In addition, capacitors C_{yer1} and Cₓₑᵣ₁ of FIG. 4 are eliminated.

As described in the first embodiment, capacitors C_{yer2}, and Cₓₑᵣ₂ are respectively charged with voltages V₂ and V₄, which are both greater than 0V, corresponding to the mean value of the voltages Vₛ/2 and −Vₛ/2, and are both less than the voltage Vₛ/2. Thus, the time of mode 1 is shorter than the time of mode 5 so that the discharge energy of capacitor C_{yer2} is less than the charge energy of capacitor C_{yer2}.

The sequential operation of the energy recovery circuit according to the third embodiment of the present invention will now be described with reference to FIGS. 12, and 13A to 13H. Here, the operation proceeds in the order of 16 modes, which arise through the manipulation of switches.

Mode 1

In mode 1, as illustrated in FIG. 12, switch Yᵣ is turned ON, with switches Y_{g} and X_{g} in the “ON” state. Then, current I_{L1} flowing to inductor L₁ is increased with a slope of Vₛ/2L₁ by a current path as shown in FIG. 13A. Energy is thus stored in inductor L₁.

Mode 2

In mode 2, as illustrated in FIG. 12, switch Y_{g} is turned OFF to form a current path as shown in FIG. 13B and cause an LC resonance. Due to the LC resonance, the Y electrode voltage V_{y} of panel capacitor Cₚ is increased, and panel capacitor Cₚ is charged. As shown in FIG. 12, the Y electrode voltage V_{y} is greater than 0V at the time when the magnitude of current I_{L1} is maximum.

Mode 3

In mode 3, as illustrated in FIG. 12, switch Yₛ is turned ON when Y electrode voltage V_{y} increases to Vₛ/2.

The Y electrode voltage V_{y} cannot exceed Vₛ/2 due to the body diode of switch Yₛ. When switch Yₛ is turned ON, the Y electrode voltage V_{y} is maintained at voltage Vₛ/2. Accordingly, the panel voltage (V_{y}-Vₓ) is maintained at the sustain-discharge voltage Vₛ so that discharge occurs. In addition, current I_{L1} flowing to inductor L₁ is recovered to the voltage Vₛ/2 on current path as illustrated in FIG. 13C.

Mode 4

Referring to FIGS. 12 and 13D, in mode 4, switch Yᵣ is turned OFF after current I_{L1} flowing to inductor L₁ becomes 0A. With switches Yₛ and X_{g} in the “ON” state, the Y and X electrode voltages V_{y} and Vₓ of panel capacitor Cₚ are maintained at Vₛ/2 and −Vₛ/2, respectively.

Mode 5

In mode 5, as illustrated in FIG. 12, switch Y_{f} is turned ON with switches YS and X_{g} in the “ON” state. Then, a current path as shown in FIG. 13E is formed, and current I_{L1} flowing to inductor L₁ is decreased (i.e., the magnitude of current I_{L1} is increased). Energy is thus charged in inductor L₁.

Mode 6

In mode 6, as illustrated in FIG. 12, switch Yₛ is turned OFF to form a current path shown in FIG. 13F, thereby causing an LC resonance. Due to the LC resonance, the Y electrode voltage V_{y} is decreased and the panel capacitor is discharged. As shown in FIG. 12, the Y electrode voltage V_{y} is greater than 0V at the time when the magnitude of current I_{L1} is maximum.

Mode 7

In mode 7, as illustrated in FIG. 12, switch Y_{g} is turned ON when the Y electrode voltage V_{y} decreases to −Vₛ/2.

The Y electrode voltage V_{y} cannot exceed −Vₛ/2 due to the body diode of switch Y_{g}. When switch Y_{g} is turned ON, the Y electrode voltage V_{y} is maintained at the voltage −Vₛ/2. In addition, current I_{L1} flowing to inductor L₁ is recovered to capacitor C_{yer2} on the current path as illustrated in FIG. 13G.

Mode 8

Referring to FIGS. 12 and 13H, in mode 8, switch Y_{f} is turned OFF after current I_{L1} flowing to inductor L₁ becomes 0A. With switches Y_{g} and X_{g} in the “ON” state, the Y and X electrode voltages V_{y} and Vₓ of are both maintained at the voltage −Vₛ/2.

In modes 1 through 8 of the third embodiment, in the same manner as the first embodiment, the panel voltage (V_{y}-Vₓ) swings between 0V and Vₛ. As shown in FIG. 12, switches Xₛ, X_{g}, Xᵣ, and X_{f} and switches Yₛ, Y_{g}, Yᵣ, and Y_{f} in modes 9 through 16 operate in the same manner as switches Yₛ, Y_{g}, Yᵣ, and Y_{f} and switches Xₛ, X_{g}, Xᵣ, and X_{f} operate in modes 1 through 8, respectively.

In the third embodiment, the driving voltage is lower than the driving voltage of the first embodiment because the maximum voltage applied to the Y and X electrodes is Vₛ/2. Accordingly, switches having a low withstand voltage can be used in the Y and X electrode sustain unit.

In addition, a power source for supplying the voltage between 0V and Vₛ/2 can be used instead of capacitors C_{yer2} and Cₓₑᵣ₂. Also, the time period of mode 1 can be longer than the time period of mode 5 so that the rise time of the panel voltage is shorter than the fall time of the panel voltage, as described in the second embodiment of the present invention.

Also, in the third embodiment, the voltages Vₛ/2 and −Vₛ/2 are applied to the Y electrode. In a modification, two voltages Vₕ and (Vₕ-Vₛ) having a voltage difference of Vₛ can be applied to the Y electrode.

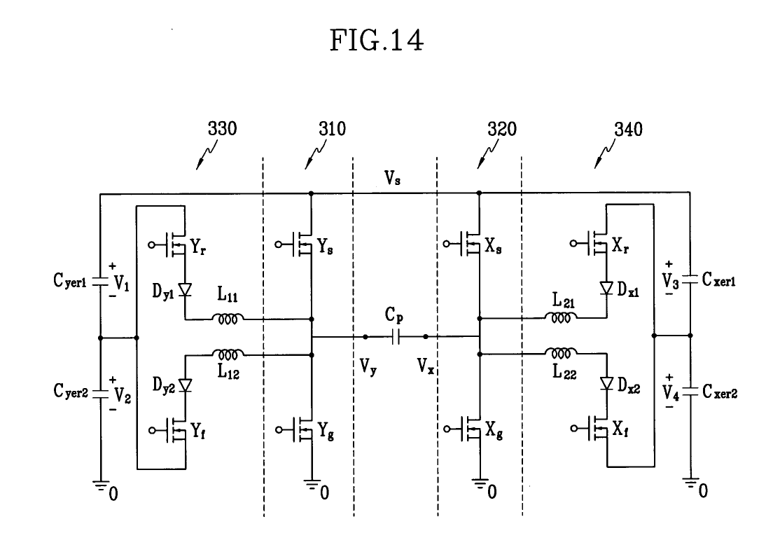

Although the same inductor L₁ is used for increasing and decreasing the Y electrode voltage V_{y} in the first through third embodiments of the present invention, independent inductors can also be used for increasing and decreasing the Y electrode voltage V_{y}. This embodiment will be described below in detail with reference to FIG. 14.

FIG. 14 is a schematic circuit diagram of an energy recovery circuit according to a fourth embodiment of the present invention.

In the energy recovery circuit as shown in FIG. 14, which differs from the first preferred embodiment, two inductors L₁₁ and L₁₂ are connected to the Y electrode of panel capacitor Cₚ in place of inductor L₁, and two inductors L₂₁ and L₂₂ are connected to the X electrode of panel capacitor Cₚ in place of inductor L₂, Inductor L₁₁ is connected between the Y electrode and switch Yᵣ, and inductor L₁₂ is connected between the Y electrode and switch Y_{f}. Likewise, inductor L₂₁ is connected between the X electrode and switch Xᵣ, and inductor L₂₂ is connected between the X electrode and switch X_{f}.

Current flows in inductor L₁₂ in modes 1 through 3, and current flows in inductor L₁₂ in modes 5 through 7. Likewise, current flows in inductor L₂₁ in modes 9 through 11, and current flows in inductor L₁₂ in modes 13 through 15.

According to the fourth embodiment of the present invention, power consumption is decreased because a current only flows in one direction in any one inductor.

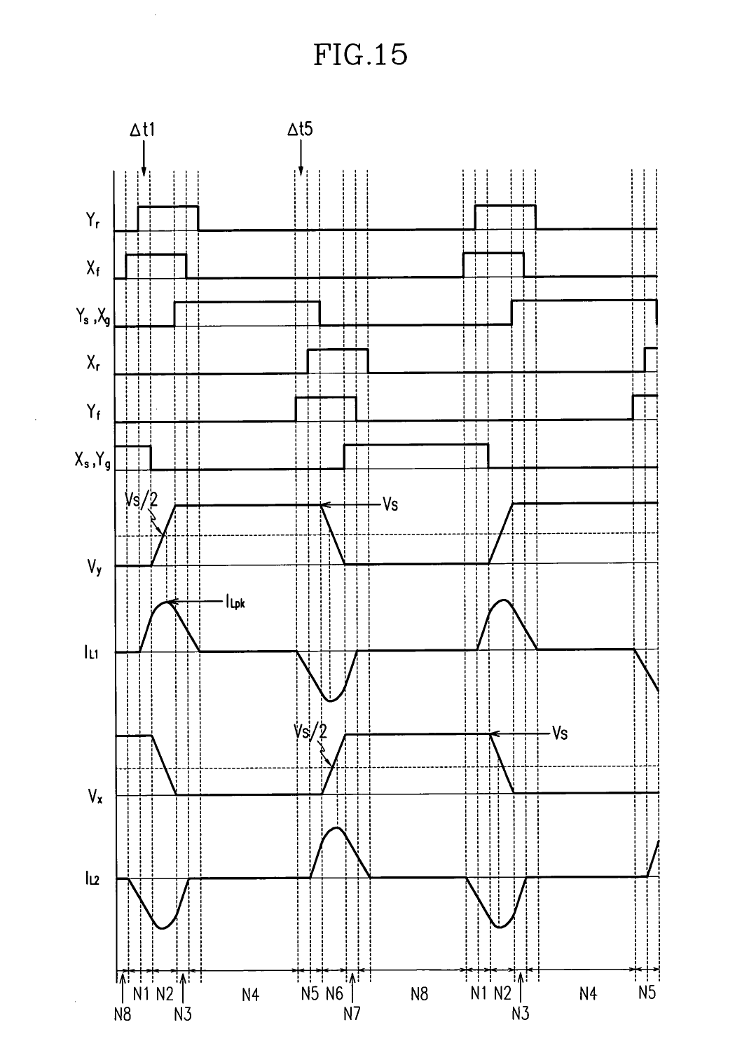

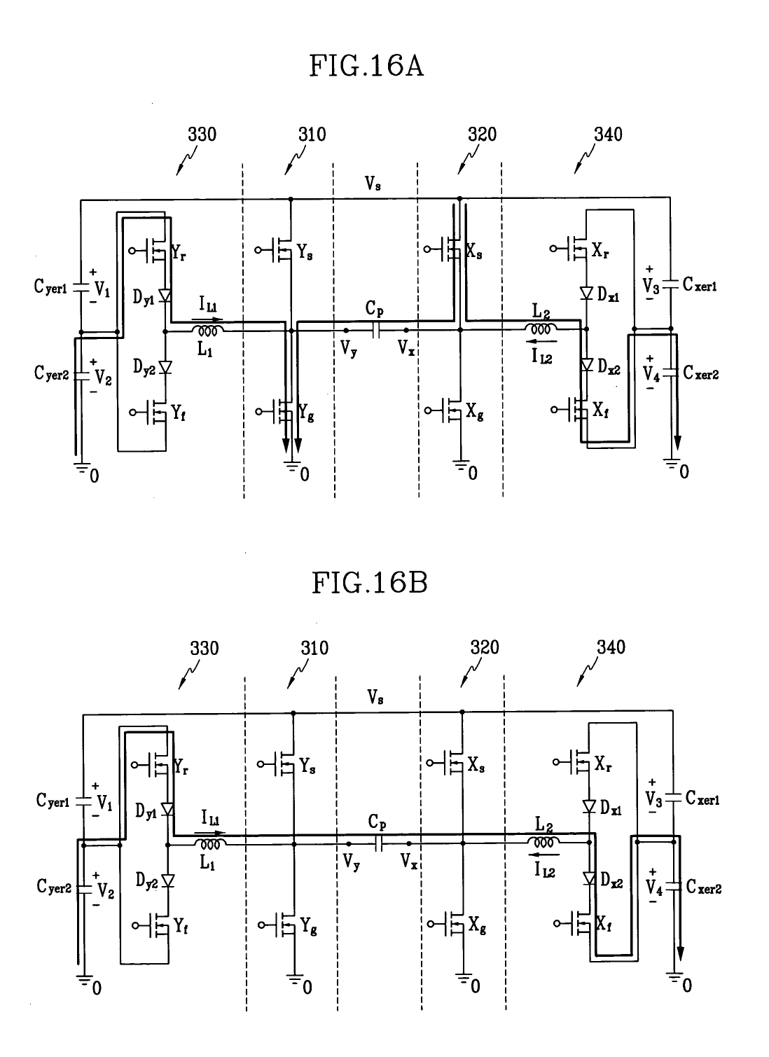

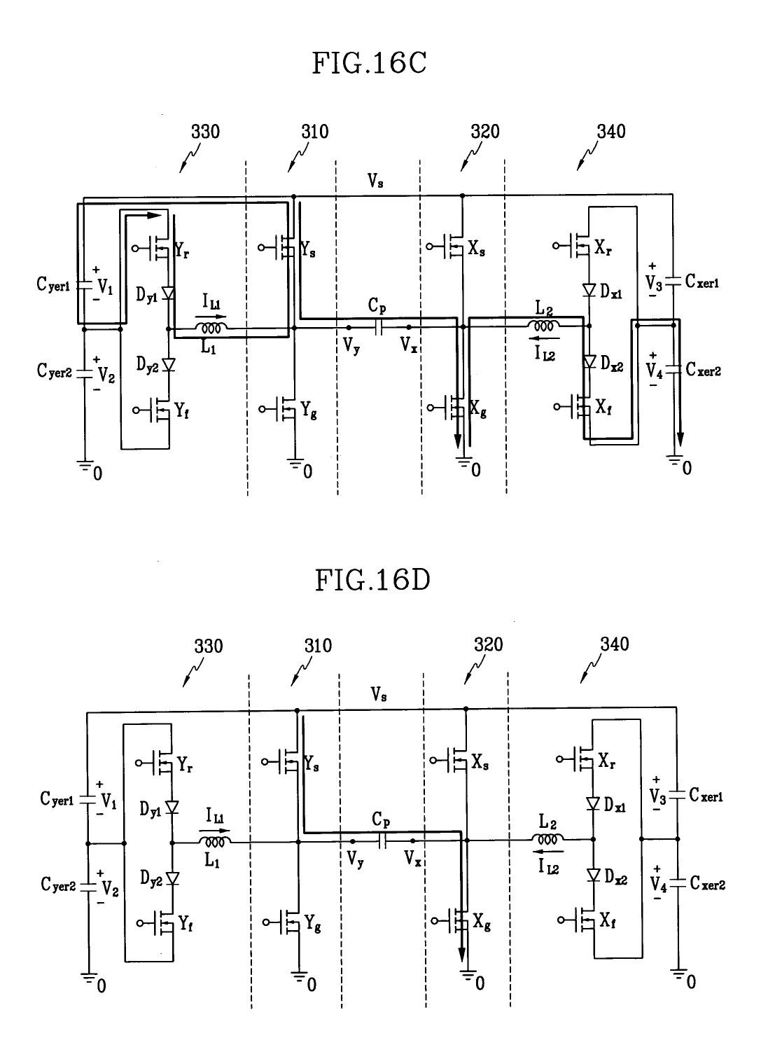

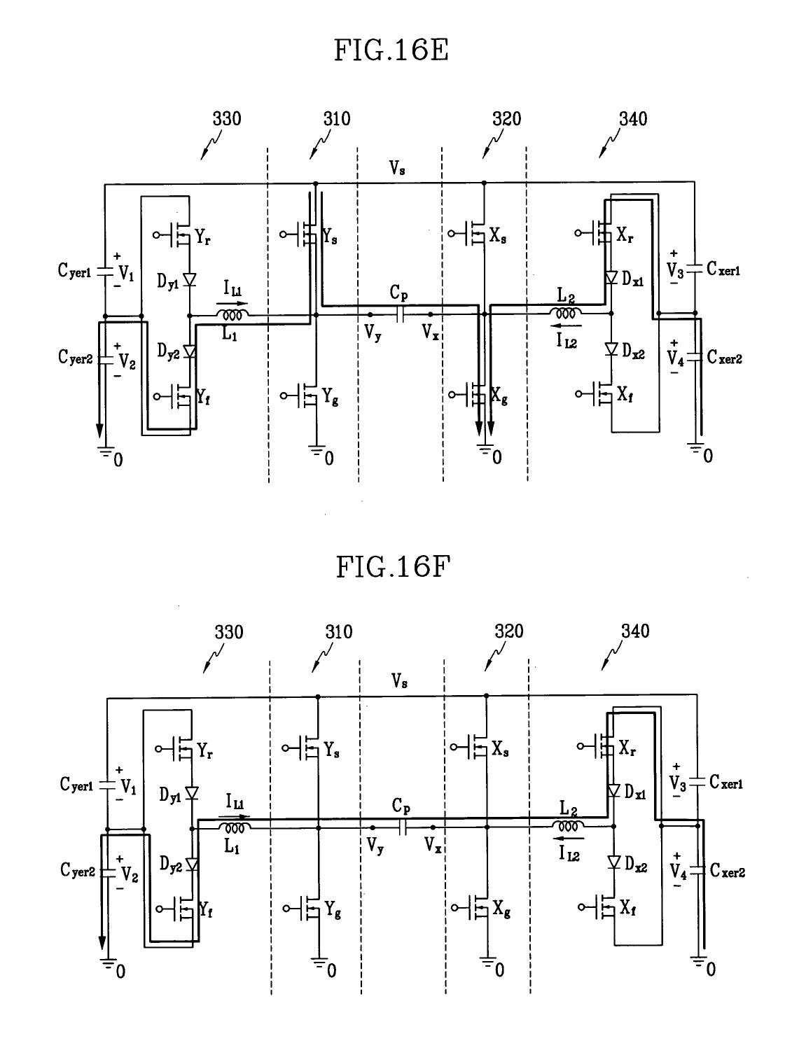

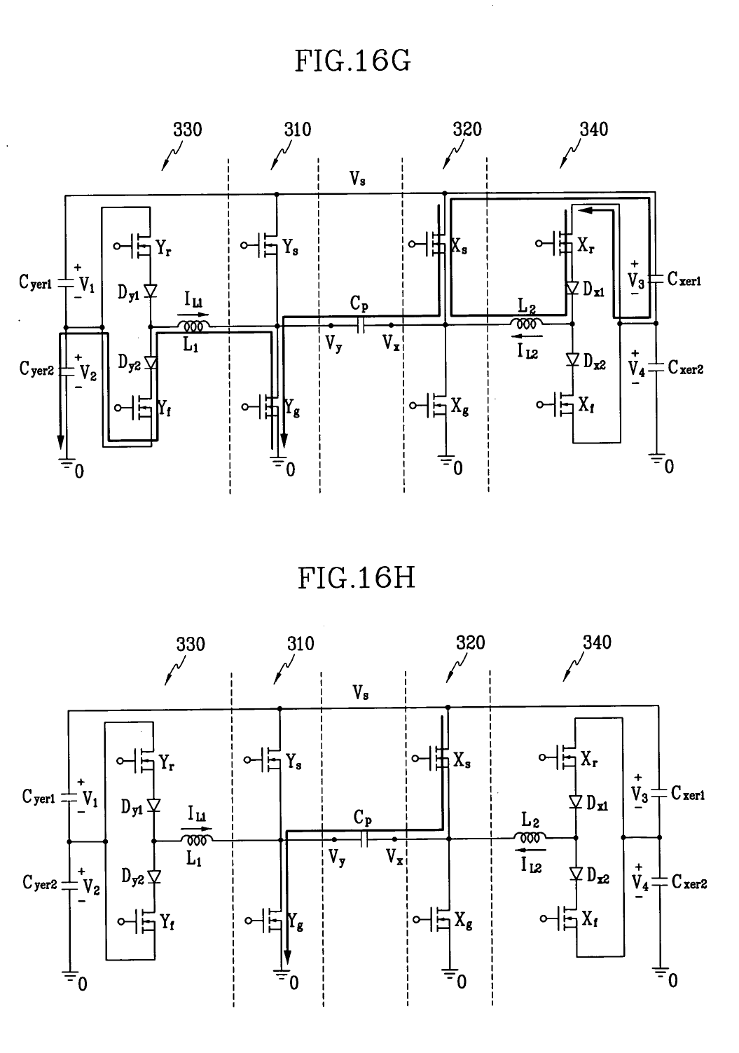

Although the Y electrode voltage V_{y} and the X electrode voltage Vₓ are changed independently in the first through fourth embodiments of the present invention, both voltages V_{y} and Vₓ can be simultaneously changed. This fifth embodiment of the present invention will be described in detail below with reference to FIGS. 15, 16A to 16H, which is a timing diagram of an energy recovery circuit according to a fifth embodiment of the present invention. FIGS. 16A to 16H are circuit diagrams showing the current path of each mode in the energy recovery circuit according to the fifth embodiment of the present invention.

As shown in FIG. 15, the timing of the energy recovery circuit according to the fifth embodiment is different from that of the energy recovery circuit according to the first embodiment. In detail, modes 1 and 13, modes 2 and 14, modes 3 and 15, modes 5 and 9, modes 6 and 10, and modes 7 and 11 of FIG. 5 are overlapped, respectively. These correspond to modes 1, 2, 3, 5, 6, and 7 of FIG. 15, respectively. Also, modes 8 and 16 of FIG. 5 are eliminated, and modes 4 and 12 of FIG. 5 correspond to modes 4 and 8 of FIG. 15.

Next, the sequential operation of the energy recovery circuit according to the fifth embodiment of the present invention will be described with reference to FIGS. 15, and 16A to 16H.

Mode 1

In mode 1, as illustrated in FIGS. 15 and 16A, switch X_{f} is initially turned ON, with switches Y_{g} and Xₛ in the “ON” state. Then a current path is formed through switch Xₛ, inductor L₂, switch X_{f}, and capacitor Cₓₑᵣ₂ in sequence. After switch X_{f} is turned ON, switch Yᵣ is turned ON so that a current path is formed through capacitor C_{yer2}, switch Yᵣ, inductor L₁ and switch Y_{g} in sequence.

Then, the magnitudes of currents I_{L1} and I_{L2} flowing to inductors L₁ and L₂ are increased with slopes of V₂/Lₗ and (V₁-V₄)/L₂, respectively. Energy is thus stored (charged) in inductors L₁ and L₂.

Mode 2

In mode 2, as illustrated in FIGS. 15 and 16B, switches Y_{g} and Xₛ are turned OFF, with switches Yᵣ and X_{f} in the “ON” state. Then, a current path is formed through capacitor C_{yer2}) switch Yᵣ, inductor L₁, panel capacitor Cₚ, inductor L₂, switch X_{f}, and capacitor Cₓₑᵣ₂ in sequence, thereby causing an LC resonance. Due to the resonance, the Y electrode voltage V_{y} of panel capacitor Cₚ increases and the X electrode voltage Vₓ decreases.

As described above, because voltage V₂ of capacitor C_{yer2} is greater than voltage Vₛ/2, the Y electrode voltage V_{y} is greater than voltage Vₛ/2 at the time when the magnitude of current I_{L1} is maximum.

Mode 3

In mode 3, as illustrated in FIGS. 15 and 16C, switches Yₛ and X_{g} are turned ON when the Y electrode voltage V_{y} has increased to Vₛ and the X electrode voltage Vₓ has decreased to 0V.

The Y electrode voltage V_{y} cannot exceed Vₛ due to the body diode of switch Yₛ. The body diode of switch Yₛ is automatically turned ON when the Y electrode V_{y} equals Vₛ. Likewise, the X electrode voltage Vₓ cannot exceed 0V due to the body diode of switch X_{g}. The body diode of switch X_{g} is automatically turned ON when the Y electrode Vₓ equals 0V. When switches Yₛ and X_{g} are turned ON, the Y and X electrode voltages V_{y} and Vₓ are maintained at Vₛ and 0V, respectively. Accordingly, the panel voltage (V_{y}-Vₓ) is maintained at the sustain-discharge voltage Vₛ so that discharge occurs.

In addition, current I_{L1} flowing to inductor L₁ is recovered to the path through is switch Yᵣ, inductor L₁, the body diode of switch Y₅, and capacitor C_{yer1} in sequence. The current I_{L2} flowing to inductor L₂ is recovered to the path through the body diode of switch X_{g}, inductor L₂, switch X_{f}, and capacitor Cₓₑᵣ₂ in sequence.

Mode 4

Referring to FIGS. 15 and 16D, in mode 4, switch X_{f} is turned OFF when current I_{L2} flowing to inductor L₂ becomes 0A. After switch X_{f} is turned OFF, switch Yᵣ is turned OFF when current I_{L1} flowing to inductor L₁ becomes 0A.

With switches Yₛ and X_{g} in the “ON” state, the Y and X electrode voltages V_{y} and Vₓ of panel capacitor Cₚ are maintained at Vₛ and 0V, respectively, and the panel voltage (V_{y}-Vₓ) is maintained at the sustain-discharge voltage Vₛ.

Mode 5

In mode 5, as illustrated in FIGS. 15 and 16E, switch Y_{f} is turned ON with switches Yₛ and X_{g} in the “ON” state. Then, a current path is formed through switch Y₅, inductor L₁, switch Y_{f}, and capacitor C_{yer2} in sequence. After switch Y_{f} is turned ON, switch Xᵣ is turned ON so that a current path is formed through capacitor Cₓₑᵣ₂, switch Xᵣ, inductor L₂, and switch X_{g} in sequence. Thus, energy is stored (charged) in inductors L₁ and L₂.

Mode 6

In mode 6, as illustrated in FIGS. 15 and 16F, switches Yₛ and X_{g} are turned OFF, with switches Y_{f} and Xᵣ in the “ON” state. Then a current path is formed through capacitor Cₓₑᵣ₂, switch Xᵣ, inductor L₂, panel capacitor Cₚ, inductor L₁, switch Y_{f}, and capacitor C_{yer2} in sequence, thereby causing an LC resonance. Due to the resonance, the Y electrode voltage V_{y} of panel capacitor Cₚ decreases and the X electrode voltage Vₓ increases.

In addition, because voltage V₄ of capacitor Cₓₑᵣ₂ is greater than voltage Vₛ/2, the X electrode voltage Vₓ is greater than voltage Vₛ/2 at the time when the magnitude of current I_{L2} is maximum.

Mode 7

In mode 7, as illustrated in FIGS. 15 and 16G, switches Y_{g} and Xₛ are turned ON when the Y electrode voltage V_{y} has decreased to 0V and the X electrode voltage Vₓ has increased to Vₛ. As described in mode 3, the Y electrode voltage V_{y} cannot exceed 0V due to the body diode of switch Y_{g}, and the X electrode voltage Vₓ cannot exceed Vₛ due to the body diode of switch Xₛ.

When switches Yₛ and X_{g} are turned ON, the Y and X electrode voltages V_{y} and Vₓ are maintained at 0V and VS, respectively. As a result, the panel voltage (V_{y}-Xₓ) is maintained at voltage −VS (the magnitude of the panel voltage is maintained at the sustain-discharge voltage Vₛ) so that discharge occurs. In addition, current I_{L1} flowing to inductor L₁ is recovered to the path through the body diode of switch Y_{g}, inductor L₁, switch Y_{f}, and capacitor C_{yer2} in sequence. Current I_{L2} flowing to inductor L₂ is recovered to the path through switch Xᵣ, inductor L₂, body diode of switch Xₛ, and capacitor Cₓₑᵣ₁ in sequence.

Mode 8

Referring to FIGS. 15 and 16D, in mode 8, switch Y_{f} is turned OFF when current I_{L1} flowing to inductor L₁ becomes 0A. After switch Y_{f} is turned OFF, switch Xᵣ is turned OFF when current I_{L2} flowing to inductor L₂ becomes 0A.

With switches Y_{g} and Xₛ in the “ON” state, the Y and X electrode voltages V_{y} and Vₓ of panel capacitor Cₚ are maintained at 0V and Vₛ respectively, and the magnitude of the panel voltage (V_{y}-Vₓ) is maintained at the sustain-discharge voltage Vₛ.

As shown in FIG. 15, in the fifth embodiment of the present invention, the time period during which switches Yᵣ and Y_{g} are both turned ON in mode 1 is shorter than the time period during which switches Yₛ and Y_{f} are both turned ON in mode 5. As a result, the discharge energy of capacitor C_{yer2} is less than the charge energy of capacitor C_{yer2}, and voltage V₂ of capacitor C_{yer2} remains at a level that is greater than Vₛ/2. Likewise, the time period during which switches X_{f} and Xₛ are both turned ON in mode 1 is longer than the time period during which switches Xᵣ and X_{g} are both turned ON in mode 5, so that the charge energy of capacitor Cₓₑᵣ₂ is greater than the discharge energy of capacitor Cₓₑᵣ₂, and voltage V₂ of capacitor Cₓₑᵣ₂ remains at a level greater than Vₛ/2.

In modes 1 through 8 of the fifth embodiment, the panel voltage (V_{y}-Vₓ) swings between −Vₛ and Vₛ. As shown in FIG. 8, switches Xₛ, X_{g}, Xᵣ, and X_{f} and switches Yₛ, Y_{g}, Yᵣ, and Y_{f} in modes 9 through 16 operate in the same manner as switches Yₛ, Y_{g}, Yᵣ, and Y_{f} and switches Xₛ, X_{g}, Xᵣ, and X_{f} operate in modes 1 through 8, respectively.

In addition, the driving method according to the second through fourth embodiments of the present invention can also be adapted to the driving method of the fifth embodiment of the present invention.

The energy recovery circuit is described in the embodiments of the present invention as connected to the Y electrode of the panel. However, as mentioned above, this energy recovery circuit can also be applied to the X electrode. Also, when the applied voltage is changed, this circuit can be applied to the address electrode.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A device for driving a plasma display panel, which has first and second electrodes with a panel capacitor formed therebetween, the device comprising:
a charge/discharge unit comprising a first inductor coupled to the first electrode, the charge/discharge unit changing the voltage of the first electrode from a first voltage to a second voltage by using the first inductor; and
a sustain unit maintaining the voltage of the first electrode at the second voltage during a predetermined period after the voltage of the first electrode is changed to the second voltage,
wherein the charge/discharge unit changes the voltage of the first electrode from the first voltage to a third voltage while increasing the magnitude of a current flowing in the first inductor, and changes the voltage of the first electrode from the third voltage to the second voltage while decreasing the magnitude of the current flowing in the first inductor; and
the third voltage is between a fourth voltage corresponding to the mean value of the first and second voltages and the second voltage.

2. The device as claimed in claim 1, wherein the charge/discharge unit changes the voltage of the first electrode by using the first inductor after storing a first energy in the first inductor.

3. The device as claimed in claim 2, wherein the sustain unit maintains the voltage of the second electrode at the first voltage while the voltage of the first electrode is changed to and maintained at the second voltage.

4. The device as claimed in claim 3, wherein the charge/discharge unit changes the voltage of the first electrode on a path including a fifth voltage being between the fourth and second voltages, the first inductor, and the panel capacitor in sequence.

5. The device as claimed in claim 4, wherein the charge/discharge further comprises a capacitor charged to the fifth voltage.

6. The device as claimed in claim 5, wherein a second energy is maintained in the first inductor after the voltage of the first electrode is changed to the second voltage.

7. The device as claimed in claim 6, wherein the first energy is greater than the second energy.

8. The device as claimed in claim 6, wherein the first energy is less than the second energy.

9. The device as claimed in claim 6, wherein the first energy is equal to the second energy.

10. The device as claimed in claim 4, wherein the charge/discharge unit changes the voltage of the first electrode from the second voltage to the first voltage, while the sustain unit maintains the voltage of the second electrode at the first voltage.

11. The device as claimed in claim 10, wherein the charge/discharge unit changes the voltage of the first electrode from the second voltage to a sixth voltage while increasing the magnitude of the current flowing in the first inductor, and changes the voltage of the first electrode from the sixth voltage to the first voltage while decreasing the magnitude of the current flowing in the first inductor; and
the sixth voltage is between the fourth and second voltages.

12. The device as claimed in claim 11, wherein the charge/discharge unit changes the voltage of the first electrode to the first voltage on a path including the panel capacitor, the first inductor, and the fifth voltage in sequence.

13. The device as claimed in claim 4, wherein the difference between the first and second voltages is a sustain-discharge voltage.

14. The device as claimed in claim 13, wherein either the first voltage or the second voltage is a ground voltage.

15. The device as claimed in claim 13, wherein either the first voltage or the second voltage is a voltage corresponding to half of a sustain-discharge voltage.

16. The device as claimed in claim 1, wherein the charge/discharge unit comprises a second inductor coupled to the second electrode and changes the voltage of the second electrode from the second voltage to the first voltage by using the second inductor while changing the voltage of the first electrode from the first voltage to the second voltage; and
the sustain unit maintains the voltage of the second electrode at the first voltage during the predetermined period after the voltage of the second electrode is changed to the first voltage.

17. The device as claimed in claim 16, wherein the charge/discharge unit changes the voltage of the second electrode from the second voltage to a fifth voltage while increasing the magnitude of a current flowing in the second inductor and changes the voltage of the second electrode from the fifth voltage to the first voltage while decreasing the magnitude of the current flowing in the second inductor; and
the fifth voltage is between the fourth and first voltages.

18. The device as claimed in claim 16, wherein the charge/discharge unit changes the voltage of the second electrode by using the second inductor after storing a second energy in the second inductor.

19. A method for driving a plasma display panel, which has first and second electrodes with a panel capacitor formed therebetween, the method comprising:
charging the panel capacitor to a first voltage, while increasing the magnitude of a current flowing in a first inductor coupled to the first electrode; and
charging the panel capacitor from the first voltage to a second voltage while decreasing the magnitude of the current flowing in the first inductor,
wherein the first voltage is between a third voltage corresponding to half of the second voltage and the second voltage.

20. The method as claimed in claim 19, wherein the second voltage is a sustain-discharge voltage.

21. The method as claimed in claim 19, further comprising: storing a first energy in the first inductor before charging the panel capacitor to a first voltage.

22. The method as claimed in claim 21, wherein a voltage of the second electrode is maintained at a fourth voltage while charging the panel capacitor to the second voltage.

23. The method as claimed in claim 22, wherein the panel capacitor is charged on a path including a fifth voltage, the first inductor, and the panel capacitor in sequence; and
the difference between the fifth voltage and the fourth voltage is between the third voltage and the second voltage.

24. The method as claimed in claim 23, wherein the fifth voltage is supplied from a capacitor.

25. The method as claimed in claim 21, wherein a second energy, which is maintained in the first inductor after charging the panel capacitor to the second voltage, is less than the first energy.

26. The method as claimed in claim 21, wherein a second energy, which is maintained in the first inductor after charging the panel capacitor to the second voltage, is greater than the first energy.

27. The method as claimed in claim 21, wherein a second energy, which is maintained in the first inductor after charging the panel capacitor to the second voltage, is equal to the first energy.

28. The method as claimed in claim 19, further comprising:
discharging the panel capacitor to a fourth voltage, while increasing the magnitude of the current flowing in the first inductor; and
discharging the panel capacitor from the fourth voltage to a ground voltage, while decreasing the magnitude of the current flowing in the first inductor.

29. The method as claimed in claim 28, wherein the fourth voltage is between the third voltage and the second voltage.

30. The method as claimed in claim 28, wherein a time period for charging the panel capacitor to the second voltage is shorter than a time period for discharging the panel capacitor to the ground voltage.

31. The method as claimed in claim 28, further comprising:
storing a first energy in the first inductor before charging the panel capacitor to the first voltage; and
storing a second energy in the first inductor before discharging the panel capacitor to the fourth voltage.

32. The method as claimed in claim 31, wherein the first energy is greater than the second energy.

33. The method as claimed in claim 21, wherein both a voltage of the first electrode and a voltage of the second electrode are changed while charging the panel capacitor to the second voltage.

34. The method as claimed in claim 33, wherein one voltage of the first and second electrodes is increased and the other voltage is decreased to charge the panel capacitor to the second voltage.

35. The method as claimed in claim 34, wherein the voltage of the second electrode is changed by a second inductor coupled to the second electrode.

36. The method as claimed in claim 35, further comprising:
storing a second energy in the second inductor before charging the panel capacitor to the first voltage.

37. A method for driving a plasma display panel, which has first and second electrodes with a panel capacitor formed therebetween, the method comprising:
injecting a current of a first direction to a first inductor coupled to the first electrode to store a first energy, while a voltage of the first electrode and a voltage of the second electrode are both maintained at a first voltage;
changing the voltage of the first electrode to a second voltage by using a resonance between the first inductor and the panel capacitor and the first energy, while the voltage of the second electrode is maintained at the first voltage; and
maintaining the voltage of the first electrode and the voltage of the second electrode at the second voltage and the first voltage, respectively,
wherein the voltage of the first electrode is firstly changed from the first voltage to a third voltage while increasing the magnitude of a current flowing in the first inductor and secondly changed from the third voltage to the second voltage while decreasing the magnitude of the current flowing in the first inductor; and
the third voltage is between a fourth voltage corresponding to the mean value of the first and second voltages and the second voltage.

38. The method as claimed in claim 37, wherein the difference between the first voltage and the second voltage is a sustain-discharge voltage.

39. The method as claimed in claim 37, wherein an energy remaining in the first inductor is decreased while maintaining the voltage of the first electrode and the voltage of the second electrode at the second voltage and the first voltage, respectively.

40. The method as claimed in claim 37, further comprising:
injecting a current of a second direction to a second inductor coupled to the first electrode to store a second energy while the voltage of the first electrode and the voltage of the second electrode are both maintained at the second voltage; and
changing the voltage of the first electrode to the first voltage by using a resonance between the second inductor and the panel capacitor and the second energy while the voltage of the second electrode is maintained at the second voltage.

41. The method as claimed in claim 40, wherein the second inductor is the first inductor, and the second direction is opposite to the first direction.

42. A method for driving a plasma display panel, which has first and second electrodes with a panel capacitor formed therebetween, the method comprising:
injecting a current of a first direction to a first inductor coupled to the first electrode to store a first energy, and injecting a current of a second direction to a second inductor coupled to the second electrode to store a second energy;
changing the voltage of the first electrode from a first voltage to a second voltage and the voltage of the second electrode from the second voltage to the first voltage by using a resonance between the first and second inductors and the panel capacitor and the first and second energies; and
maintaining the voltage of the first electrode and the voltage of the second electrode at the second voltage and the first voltage, respectively,
wherein the voltage of the first electrode is firstly changed from the first voltage to a third voltage while increasing the magnitude of a current flowing in the first inductor and secondly changed from the third voltage to the second voltage while decreasing the magnitude of the current flowing in the first inductor; and
the third voltage is between a fourth voltage corresponding to the mean value of the first and second voltages and the second voltage.

43. The method as claimed in claim 42, wherein the difference between the first voltage and the second voltage is a sustain-discharge voltage.

44. The method as claimed in claim 37, wherein energies remaining in the first and second inductors are decreased while maintaining the voltage of the first electrode and the voltage of the second electrode at the second voltage and the first voltage, respectively.

45. The method as claimed in claim 37, further comprising:
injecting a current of a third direction to a third inductor coupled to the first electrode to store a third energy, and injecting a current of a fourth direction to a fourth inductor coupled to the second electrode to store a fourth energy; and
changing the voltage of the first electrode from the second voltage to the first voltage and the voltage of the second electrode from the first voltage to the second voltage by using a resonance between the third and fourth inductors and the panel capacitor and the third and fourth energies.

46. The method as claimed in claim 45, wherein the third inductor is the first inductor, and the third direction is opposite to the first direction; and
the fourth inductor is the second inductor, and the fourth direction is opposite to the second direction.

47. A plasma display device, comprising:
a plasma display panel having first and second electrodes with a panel capacitor formed therebetween; and
a driving circuit comprising an inductor coupled to the first electrode, the driving circuit applying a driving voltage to the first electrode,
wherein the driving circuit firstly charges the panel capacitor to a voltage greater than half of a desired voltage while increasing the magnitude of a current flowing in the inductor, and secondly charges the panel capacitor to the desired voltage while decreasing the magnitude of the current flowing in the inductor.

48. The plasma display device as claimed in claim 47, wherein the driving circuit stores energy in the inductor before charging the panel capacitor.

49. A plasma display device, comprising:
a plasma display panel having first and second electrodes with a panel capacitor formed therebetween; and
a driving circuit comprising first and second inductors coupled to the first electrode in parallel, the driving circuit applying a driving voltage to the first electrode,
wherein the driving circuit firstly charges the panel capacitor to a voltage greater than half of a desired voltage while increasing the magnitude of a current flowing in the first inductor, and secondly charges the panel capacitor to the desired voltage while decreasing the magnitude of the current flowing in the first inductor; and
the driving circuit discharges the panel capacitor by using the second inductor.

50. The plasma display device as claimed in claim 49, wherein the driving circuit stores a first energy in the first inductor before charging the panel capacitor.

51. The plasma display device as claimed in claim 51, wherein the driving circuit stores a second energy in the second inductor before discharging the panel capacitor.
